(19) United States
(12) Patent Application Publication
(10) Pub. No.: US 2025/0200725 A1
(43) Pub. Date: Jun. 19, 2025

(54) SPECTRAL ENCODING

(71) Applicant: INTERNATIONAL BUSINESS MACHINES CORPORATION, ARMONK, NY (US)

(72) Inventors: Jitendra SINGH, NOIDA (IN); Hendrick F. HAMANN, BEDFORD, NY (US); Kamal Chandra DAS, NEW DELHI (IN); Himanshu GUPTA, NEW DELHI (IN)

(21) Appl. No.: 18/539,879

(22) Filed: Dec. 14, 2023

(51) Int. Cl. G06T 5/70; G06T 5/20; G06V 10/774; G06V 10/776

(52) U.S. Cl. CPC G06T 5/70; G06T 5/20; G06V 10/774; G06V 10/776; G06T 2207/10032; G06T 2207/20081

(57) ABSTRACT

Methods, computer program products, and systems are presented. The method computer program products, and systems can include, for instance: encoding one or more instance of a received image with spectral mask data, wherein the spectral mask data specifies spectral information of the received image to be masked; training one or more predictive model in dependence on the encoding; querying the one or more predictive model with a query image; and performing processing in dependence on an output from the querying.

### BACKGROUND

Embodiment herein relate generally to image processing and specifically to spectral encoding.

Data structures have been employed for improving operation of a computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: encoding one or more instance of a received image with spectral mask data, wherein the spectral mask data specifies spectral information of the received image to be masked; training one or more predictive model in dependence on the encoding; querying the one or more predictive model with a query image; and performing processing in dependence on an output from the querying.

In one embodiment, the output from the querying includes output prediction data specifying missing spectral information, and in a further aspect the performing processing includes examining the prediction data, and transforming the query image into a formatted spectrally enhanced image based on the examining.

In one embodiment, the output from the querying includes an output one or more prediction label, and in a further aspect the performing processing includes examining the one or more prediction label, and recognizing a condition based on the examining.

In one embodiment, the output from the querying includes a plurality of pixel specific prediction labels, and wherein the performing processing includes examining pixel specific prediction labels of the plurality of pixel specific prediction labels, and recognizing a condition based on the examining.

In one embodiment, the query image is provided by a multi-pixel query image, wherein the output from the querying includes a multi-pixel image associated prediction label attached to the multi-pixel query image, and in a further aspect the performing processing includes examining the multi-pixel image associated prediction label, and recognizing a condition based on the examining.

In one embodiment, the training the one or more predictive model in dependence on the encoding includes training a foundation model using unlabeled training data in which spectral channels are masked, training an instance of the foundation model employing fine tuning training with use of labeled training data to define a specific task model, and further training the specific task model employing fine tuning training with use of additional labeled training data, and in a further aspect according to the embodiment the output from the querying includes an output one or more prediction label, and in a further aspect the performing processing includes examining the one or more prediction label, recognizing a condition based on the examining, and returning an action decision based on the recognizing.

In another aspect, a computer program product can be provided. The computer program product can include a computer readable storage medium readable by one or more processing circuit and storing instructions for execution by one or more processor for performing a method. The method can include, for example: encoding one or more instance of a received image with spectral mask data, wherein the spectral mask data specifies spectral information of the received image to be masked; training one or more predictive model in dependence on the encoding; querying the one or more predictive model with a query image; and performing processing in dependence on an output from the querying.

In a further aspect, a system can be provided. The system can include, for example a memory. In addition, the system can include one or more processor in communication with the memory. Further, the system can include program instructions executable by the one or more processor via the memory to perform a method. The method can include, for example: encoding one or more instance of a received image with spectral mask data, wherein the spectral mask data specifies spectral information of the received image to be masked; training one or more predictive model in dependence on the encoding; querying the one or more predictive model with a query image; and performing processing in dependence on an output from the querying.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1A depicts system having a manager system, plurality of satellite imaging systems, enterprise systems, according to one embodiment;

FIG. 1B depicts a user interface according to one embodiment;

FIG. 2 is a flowchart depicting a method for performance by manager system interoperating with imaging systems, and enterprise systems according to one embodiment;

FIG. 3A is a representation of a spectral image according to one embodiment;

FIG. 3B is a representation of a spectral image according to one embodiment;

FIG. 3C is a chart depicting attributes of a formatted spectral image according to one embodiment;

FIG. 3D is a chart depicting attributes of a formatted spectral image according to one embodiment;

FIG. 3E depicts a foundation model architecture according to one embodiment;

FIG. 4A depicts a foundation model architecture according to one embodiment;

FIG. 4B depicts a foundation model according to one embodiment;

FIG. 4C depicts a specific task model according to one embodiment;

FIG. 4D depicts training for providing a specific task model according to one embodiment;

FIG. 4E depicts training for providing a specific task model according to one embodiment;

FIG. 4F depicts training for providing a specific task model according to one embodiment;

FIG. 5 depicts a system architecture according to the system as shown in FIG. 1A according to one embodiment;

FIG. 6 depicts spectral foundation model according to one embodiment;

FIG. 7 depicts computing environment according to one embodiment.

### DETAILED DESCRIPTION

In one aspect, embodiments herein can optionally include encoding one or more instance of a received image with spectral mask data, wherein the spectral mask data specifies spectral information of the received image to be masked; training one or more predictive model in dependence on the encoding; querying the one or more predictive model with a query image; and performing processing in dependence on an output from the querying. According to an example of a technical effect of the combination, spectral enhancement of an input query image can be provided. In another aspect, a predictive model can be provisioned via training to control an aspect of processing.

According to one optional feature, the output from the querying includes output prediction data specifying missing spectral information, and the performing processing includes examining the prediction data, and transforming the query image into a formatted spectrally enhanced image based on the examining. According to an example of a technical effect of the combination, the combination can produce a spectrally enhanced image featuring, e.g., reduced noise.

According to one optional feature, the output from the querying includes one or more prediction label, and the performing processing includes examining the one or more prediction label, and recognizing a condition based on the examining. According to an example of a technical effect of the combination, improved condition recognition can be provided that is improved at least by spectral enhancement features that can spectrally enhance an input image.

According to one optional feature, the output from the querying includes a plurality of pixel specific prediction labels, and the performing processing includes examining pixel specific prediction labels of the plurality of pixel specific prediction labels, and recognizing a condition based on the examining. According to an example of a technical effect of the combination, improved condition recognition can be provided that is improved at least by spectral enhancement features that can spectrally enhance an input image.

According to one optional feature, the query image is provided by a multi-pixel query image, the output from the querying includes a multi-pixel image associated prediction label attached to the multi-pixel query image, and the performing processing includes examining the multi-pixel image associated prediction label, and recognizing a condition based on the examining. According to an example of a technical effect of the combination, improved condition recognition can be provided that is improved at least by spectral enhancement features that can spectrally enhance an input image.

According to one optional feature, the one or more predictive model includes a foundation model and a specific task model. According to an example of a technical effect of the combination, the architecture of the combination provides for multiple interfaces for query. The multiple interfaces can be queried for differentiated purposes, e.g., foundation model for recognition independent image enhancement, and the specific task model for condition recognition. In one aspect, a foundation model can be rapidly trained for deployment with use of computing resource economized training processes unencumbered by processes for labeling training data.

According to one optional feature, the one or more predictive model includes a foundation model and a specific task model, the output from the querying includes an output one or more prediction label, and the performing processing includes examining the one or more prediction label, recognizing a condition based on the examining, and returning an action decision based on the recognizing, wherein the specific task model is selected from the group consisting of a classification specific task model, a segmentation specific task model, and a regression specific task model. According to an example of a technical effect of the combination, the combination provides for precision condition recognition control of a mechanical system. A foundation model can be rapidly trained for deployment with use of computing resource economized training processes unencumbered by processes for labeling training data.

According to one optional feature, the output from the querying includes a recognition result, and the performing processing includes controlling a mechanical system in dependence on the recognition result. According to an example of a technical effect of the combination, the combination provides for precision condition recognition control of a mechanical system.

According to one optional feature, the output from the querying includes output prediction data specifying missing spectral information, and the performing processing includes examining the prediction data, and providing a formatted spectrally enhanced image based on the examining, and the performing processing includes archiving the formatted spectrally enhanced image, wherein the formatted spectrally enhanced image is formatted in an M/HS format. According to an example of a technical effect of the combination, the combination can produce a spectrally enhanced image featuring, e.g., reduced noise.

According to one optional feature, the output from the querying includes a plurality of pixel specific prediction labels, and the performing processing includes examining pixel specific prediction labels of the plurality of pixel specific prediction labels, and recognizing a condition based on the examining, and storing a recognition result resulting from the recognizing. According to an example of a technical effect of the combination, the combination can provide improved recognition processing, improved at least by spectral enhancement of an input image.

According to one optional feature, the performing processing includes controlling a mechanical system in dependence on a recognition result, the recognition result based on an examining of the output. According to an example of a technical effect of the combination, the combination provides for precision condition recognition control of a mechanical system, improved at least by spectral enhancement of an input image.

According to one optional feature, the training of the one or more predictive model in dependence on the encoding includes training a foundation model using training data in which spectral channels are masked, training an instance of the foundation model with use of fine tuning training to define a specific task model, and further training the specific task model with use of fine tuning training, wherein the performing processing includes returning an action decision based on an examining of the output. According to an example of a technical effect of the combination, the combination provides for precision condition recognition control of a mechanical system, improved at least by spectral enhancement of an input image. A foundation model can be rapidly trained for deployment with use of computing resource economized training processes unencumbered by processes for labeling training data.

According to one optional feature, the training of the one or more predictive model in dependence on the encoding includes training a foundation model using unlabeled training data in which spectral channels are masked, training an instance of the foundation model employing fine tuning training with use of labeled training data to define a specific task model, and further training the specific task model employing fine tuning training with use of additional labeled training data, the output from the querying includes an output one or more prediction label, and the performing processing includes examining the one or more prediction label, recognizing a condition based on the examining, and returning an action decision based on the recognizing. According to an example of a technical effect of the combination, the combination provides for precision condition recognition control of a mechanical system, improved at least by spectral enhancement of an input image. A foundation model can be rapidly trained for deployment with use of computing resource economized training processes unencumbered by processes for labeling training data.

According to one optional feature, the method is characterized by one or more of the following selected from the group consisting of: (a) the received image is a satellite spectral image. (b) the received image is defined by an X×Y pixel array in which pixel intensity values for respective pixels of the array are provided for M channels. (c) the received image includes M channels, and (d) the received image includes M channels, and wherein the spectral mask data specifies selective masking of a subset of the M channels. According to an example of a technical effect of the combination, the combination provides for spectral enhancement of multiple channels.

According to one optional feature, the encoding the one or more instance of a received image with spectral mask data includes encoding a first instance of the received image with first spectral mask data that specifies selective masking of a first channel of the received image, and wherein the encoding one or more instance of the received image with spectral mask data includes encoding a second instance of the received image with second spectral mask data that specifies selective masking of a second channel of the received image. According to an example of a technical effect of the combination, the combination provides for spectral enhancement of an input image.

According to one optional feature, the encoding one or more instance of a received image with spectral mask data includes encoding a first instance of the received image with first spectral mask data that specifies selective masking of a first channel of the received image, the encoding one or more instance of a received image with spectral mask data includes encoding a second instance of the received image with second spectral mask data that specifies selective masking of a second channel of the received image, wherein the training the one or more predictive model in dependence on the encoding includes applying a first training dataset to a foundation model with the first channel masked, and applying a second training dataset for the foundation model with the second channel masked. According to an example of a technical effect of the combination, the combination provides for spectral enhancement of an input image. A foundation model can be rapidly trained for deployment with use of computing resource economized training processes unencumbered by processes for labeling training data.

According to one optional feature, the encoding one or more instance of a received image with spectral mask data includes encoding a first instance of the received image with first spectral mask data that specifies selective masking of a first channel of the received image, and the encoding one or more instance of a received image with spectral mask data includes encoding a second instance of the received image with second spectral mask data that specifies selective masking of a second channel of the received image, wherein the training the one or more predictive model in dependence on the encoding includes applying a first training dataset to a foundation model with the first channel masked, and applying a second training dataset for the foundation model with the second channel masked, wherein the training the one or more predictive model in dependence on the encoding includes training the foundation model using unlabeled training data in which spectral channels are masked in accordance with the encoding, training an instance of the foundation model employing fine tuning training with use of labeled training data to define a specific task model, and further training the specific task model employing fine tuning training with use of additional labeled training data, wherein the performing processing includes returning an action decision based on an examining of the output, wherein the output from the querying includes an output one or more prediction label output from the specific task model, and wherein the performing processing includes examining the one or more prediction label, recognizing a condition based on the examining, and retuning an action decision based on the recognizing. According to an example of a technical effect of the combination, the combination provides for precision condition recognition control of a mechanical system, improved at least by spectral enhancement of an input image. A foundation model can be rapidly trained for deployment with use of computing resource economized training processes unencumbered by processes for labeling training data.

According to one optional feature, the performing processing in dependence on an output from the querying includes returning an action decision in dependence on an output from the querying. According to an example of a technical effect of the combination, the combination provides for precision condition recognition control of a mechanical system, improved at least by spectral enhancement of an input image.

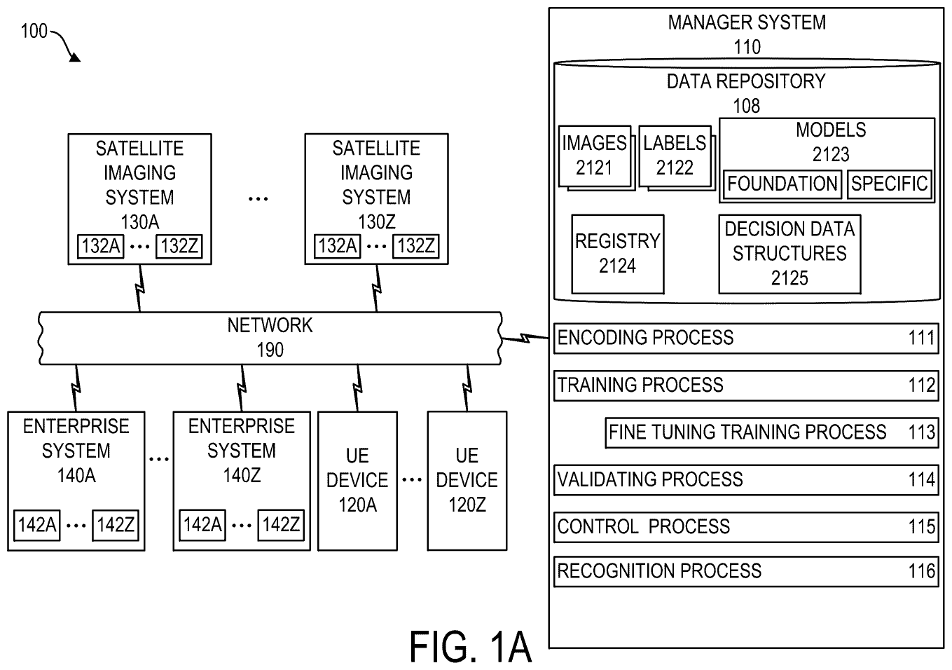

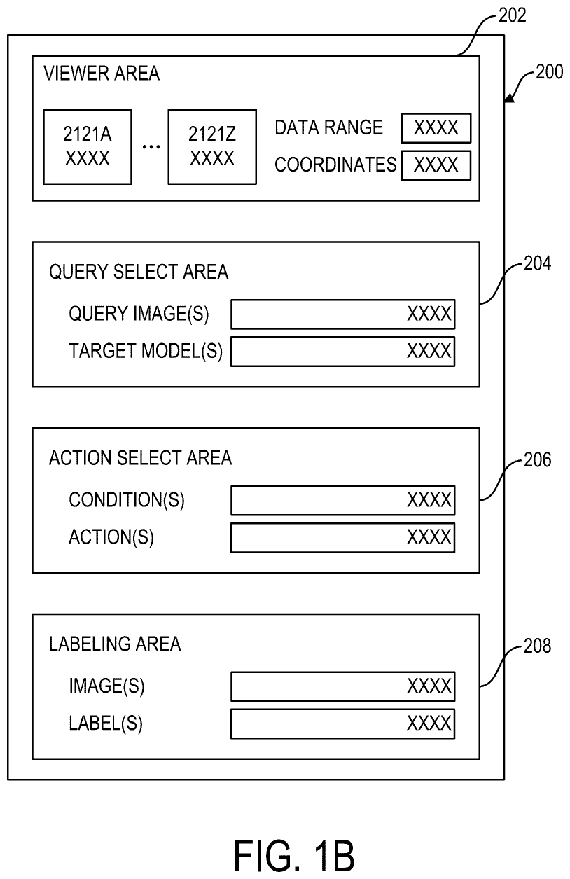

System 100 for use in spectral encoding is shown in FIG. 1A. System 100 can include manager system 110 having an associated data repository 108, user equipment (UE) devices 120A-120Z, satellite imaging systems 130A-130Z, and enterprise systems 140A-140Z. Manager system 110, satellite imaging systems 130A-130Z, and enterprise systems 140A-140Z can be in communication with one another via network 190. System 100 can include numerous devices which can be computing node based devices connected by network 190. Network 190 can be a physical network and/or a virtual network. A physical network can include, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. In the context of user equipment (UE) devices 120A-120Z, satellite imaging systems 130A-130Z, and enterprise systems 140A-140Z, “Z” can be any number.

In one embodiment, manager system 110 can be external to UE devices 120A-120Z, satellite imaging systems 130A-130Z and enterprise systems 140A-140Z. In another embodiment, manager system 110 can be co-located with one or more instance of satellite imaging systems 130A-130Z and/or enterprise systems 140A-140Z. Manager system 110, in one example, can perform services for third parties. In such an example, manager system 110 can be external to enterprise system 140A-140Z. Manager system 110, in one example, can be operated by an enterprise and used by the enterprise for performance of an internal service for the benefit of the enterprise. In such an embodiment (and in other embodiments), manager system 110 can be co-located with an enterprise system of enterprise systems 140A-140Z.

Manager system 110, instances of UE devices 120A-120Z, satellite imaging systems 130A-130Z and instances of enterprise systems 140A-140Z can respectively include one or more computing node.

With further reference to FIG. 1A, respective satellite imaging systems 130A-130Z can include, respectively, one or more sensors 132A-132Z. In one embodiment, each respective satellite imaging system 130A-130Z can include a plurality of sensors 132A-132Z. In one example, each respective sensor of the one or more sensors 132A-132Z can include differentiated ranges of spectral sensitivity. Satellite imaging systems 130A-130Z having one or more sensor 132A-132Z can produce spectral image data defined by a plurality of spectral channels. In one example, a spectral image produced by a satellite imaging system can include an X×Y array of pixels defined by pixel positions wherein respective pixels (pixel positions) of the pixel array include pixel intensity values across multiple spectral channels (channels). Spectral image data defining a spectral image output by satellite imaging systems 130A-130Z can be formatted according to a predetermined spectral image data format.

In one embodiment, satellite imaging systems 130A-130Z can produce spectral image data formatted according to the Sentinel 2 Multispectral image data format. The Sentinel 2 multi-spectral image data format includes 13 bands. In another embodiment, the satellite imaging systems 130A-130Z can produce spectral image data formatted according to the Hyperion Hyperspectral image data format. The Hyperion Hyperspectral image data format includes 242 bands. Satellite imaging systems 130A-130Z can produce spectral image data according to a single format or according to multiple formats, e.g., some satellite imaging systems 130A-130Z can produce Sentinel 2 Multispectral image data without producing Hyperion Hyperspectral formatted image data, some satellite imaging systems of satellite imaging systems 130A-130Z can produce Hyperion Hyperspectral formatted image data without producing Sentinel 2 Multispectral image data, while other satellite imaging systems of satellite imaging systems 130A-130Z can produce both Sentinel 2 Multispectral image data as well as Hyperion Hyperspectral formatted image data. Images herein that are formatted according to the Sentinel 2 Multispectral format and/or the Hyperion Hyperspectral format are referred to herein a multi/hyper spectral images (M/HS). In one embodiment, satellite imaging systems 130A-130Z can be replaced with non-satellite imaging systems such that multi-channel image data output from the imaging systems is non-satellite image data.

With further reference to FIG. 1A, the respective enterprise systems 140A-140Z can include respective mechanical systems 142A-142Z which can be controlled by manager system 110 responsively to result data output responsively to query of a predictive model. The mechanical systems 142A-142Z can include, e.g., robots, e.g., vehicular or non-vehicular, irrigation systems, applications systems, other process control systems and the like.

Data repository 108 of manager system 110 can store various data. In images area 2121, data repository 108 can store images, e.g., non-satellite or satellite images which have been collected by satellite imaging systems 130A-130Z so that data repository 108 defines an archive of historical images. Data repository 108 can store each collected image (or a sample of collected image) permanently. In one embodiment, data repository 108 can iteratively buffer each newly collected satellite images into a buffer storage memory defining images area 2121 and can discard a portion of aged images so that a sample of historical images are retained long term in data repository 108 defining an archive of historical images.

Data repository 108 in models area 2122 can store predictive models which have been trained with use of training data to predict missing spectral information on being queried with spectral information of collected images. Models of model area 2122 can have various states, e.g., pre-validated or validated. The states valid or not valid can be provided for various coordinate ranges, referred to as geospatial regions. A certain geospatial region can have a certain coordinate range. Manager system 110 can be configured to graduate a model from a not valid state to valid state based on validating of a model. Manager system 110 can determine that a model has a pre-validated state when the model fails to perform a prediction within a threshold satisfying level of accuracy.

Manager system 110 can determine that a model has a validated state when the model performs a prediction within a threshold satisfying level of accuracy. Manager system 110 can test a trained model using holdout data. Manager system 110 can separate a test image into holdout data (defining a ground truth) and remaining data. For testing of a model, manager system 110 can query a trained model with remaining data of test image after holdout data separation, and manager system 110 can compare predicted data values output by the model resulting from the query to data values of the holdout data.

Data repository 108 in labels area 2122 can store labels associated to images. From time to time manager system 110 can intake labels associated to image data. In one embodiment, administrator users of manager system 110 and system 100 can specify labels to be associated to archived images which archived images can be stored in images area. In one embodiment, administrator users of manager system 110 and system 100 can specify labels to be associated to archived images which archived images can be stored in images area. In one use case, a label can specify an object or other attribute associated to an image defined by a set of pixels. In one use case, a label can specify an object or other attribute associated to a pixel forming part of an image. Manager system 110 can train predictive models herein with use labeled image data. In one embodiment, manager system 110 can perform fine tuning training of an instance of a spectral foundation model using labeled image data in order to provide a specific task model.

Models of models area 2123 can include, in one embodiment, a foundation model (general model) and one or more specific task model which can be provided by subjecting an instance of the foundation model to fine tuning training. A foundation model can be a spectral foundation model that has been trained with spectrally masked images for performance of predictions of missing spectral information within an input image that can be input as a query image. An instance of the foundation model can be further trained by fine tuning training to define a specific task model, which specific task model can be subject to further training according to a fine tuning training process. A specific task model, on being trained, can be configured to return predictions as to a specific task. The specific task can be the task of recognizing a certain condition. The certain condition can be, e.g., that a certain object is represented within an image.

Data repository 108 in registry area 2124 can include data specifying identifiers and states of predictive models being trained and deployed for use by manager system 110. Models referenced in registry area 2124 can be tagged, e.g., with identifiers for the models, their types, e.g., foundation or specific task, their task (if a specific task model), their geospatial location, e.g., coordinate location range subject imaging, and their states, e.g., pre-validated or validated, volume of training data.

Data repository 108 in decision data structure area 2125 can store decision data structures for return of action decisions. Decision data structures can include, e.g., decision lists, decision tables, and/or decision trees.

Manager system 110 can run various processes. Manager system 110 running encoding process 111 can include manager system 110 encoding collected spectral images with mask data that specifies one or more channel defining the spectral image as a masked channel. In one embodiment, manager system 110 can replicate a collected image M-1 times so that there are M instances of respective incoming collected images collected by manager system 110. Manager system 110 can encode the respective M instances with differentiated mask data. For example, mask data for a first instance of a certain image can specify that a first channel is masked, and mask data for a second instance of the image can specify that a second channel of the certain image is masked. Spectral autoencoding of mask data can be performed, e.g., on a fixed pattern basis or a random basis.

Manager system 110 running training process 112 can include manager system 110 training a spectral predictive model in dependence on encoded mask data encoded by the encoding process 111. For training a spectral predictive model, iterations of training data for training the predictive model can include (a) information of a masked one or more channel of an image instance (defining a training outcome), (b) an information of remaining (unmasked) channels of the image instance (defining a training input), and geospatial region of the image instance. Where there are produced M masked instances of certain spectral image, manager system 110 can apply M sets of training data for that certain spectral image and manager system 110 can repeat the described training process for P successive spectral images where P can include, e.g., tens, hundreds, thousands, millions or more training images that are iteratively collected from satellite imaging systems 130A-130Z over time. The described spectral predictive model can define a foundation model.

Manager system 110 running training process 112 can include manager system 110 training one or more foundation model and can include manager system 110 training one or more specific task model by use of fine tuning training process 113.

For providing a specific task model, manager system 110 can further train an instance of a trained foundation model by manager system 110 running fine tuning training process 113 using specific task labeled training data. For performing fine tuning training data, manager system 110 can apply labeled image data to an instance of a foundation model such that the model is trained on a relationship between the input image data and outcome label data.

Manager system 110 running validating process 113 can perform testing of a trained predictive model to determine whether a trained predictive model is ready for deployment. Manager system 110 performing validating process 113 can test a trained predictive model to determine whether the trained predictive model exhibits a threshold satisfying level of performance. Manager system 110 performing validating process 113 can test a trained predictive model using holdout data. For example, manager system 110 can collect a test image and can encode the test image so that the subset of data defining the test image is held out and tagged as holdout data. For testing a trained predictive model, the remaining data defining the test image that is not held out can be applied as query data. Manager system 110 can examine a result of the query using the holdout data. Manager system 110 can compare predicted missing data on being queried with remaining data and manager system 110 can compare the predicted missing data to the holdout data in order to determine an accuracy performance parameter value of the predictive model.

Manager system 110 running control process 115 can provide one or more service to one or more enterprises operating enterprise system 140A-140Z. In one example, manager system 110 providing a service to an enterprise can include manager system 110 running a recognition process to perform condition recognition and can also include manager system 110 running control process 115 in order to control a process in response to a condition recognition. Manager system 110 running control process 115 can include manager system 110 performing a control process responsively to a condition recognition.

In one example, manager system 110 can recognize a changed condition and can control a mechanical system in response to the recognition. The mechanical system can include, e.g., a robot, an irrigation system, an agricultural treatment system, a roadway sign array, and the like. In one example, manager system 110 can recognize a condition, e.g., a changed condition or specified condition in an agricultural geospatial area (e.g., crop) and can control a mechanical system, e.g., irrigation system or pesticide application system responsively to the condition being recognized.

In one embodiment, manager system 110 running recognition process 116 can include manager system 110 querying a predictive model trained by way of supervised machine learning with use of labeled image data, and examining result data output from the predictive model from the querying.

In one example, manager system 110 can recognize a dangerous road condition and can control the roadway sign array as a result of the recognition. In one example, manager system 110 can deploy vehicle based robots to address a detected dangerous road condition, e.g., can auto navigate the snow robotic autonomous snow removal vehicle resulting from a recognition of a snow covering condition. In another example, manager system 110 running control process 115 can include manager system 110 recognizing and providing output control in reference to a changing agricultural condition. A geospatial area subject to monitoring can be a farming geospatial area and recognition of a condition by recognition process can include recognizing a changed crop condition e.g., drying, infestation, storm damage, and the like. Manager system 110 running control process in such a scenario can include a control, e.g., to adjust timing of a timed sprinkler system for the crop or can include, e.g., a control delivered to an enterprise for adjusting timing operation of a machine, e.g., a robot for delivery of pesticide.

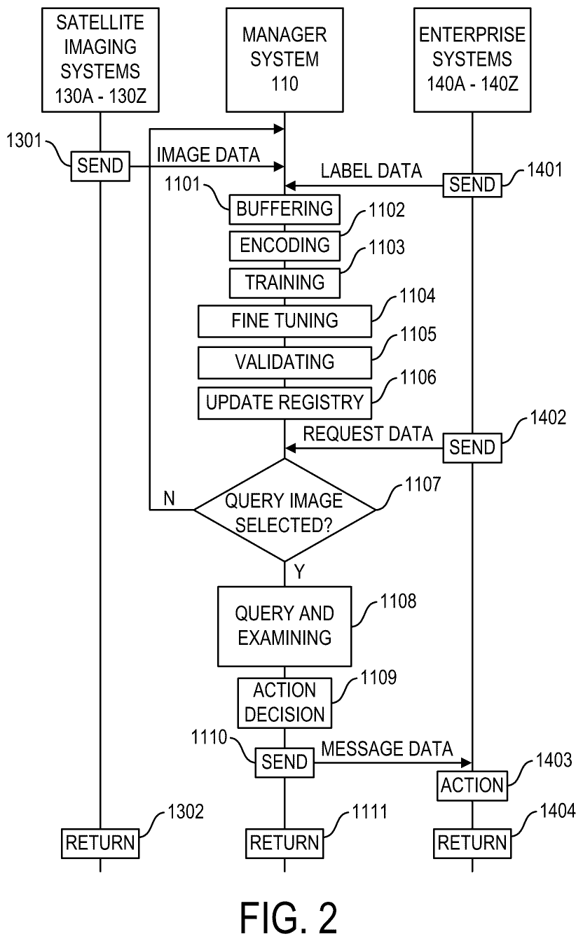

A method for performance by manager system 110 interoperating with satellite imaging systems 130A-130Z and enterprise systems 140A-140Z is set forth in reference to FIG. 2.

At block 1301, satellite imaging systems 130A-130Z can be sending spectral satellite images to manager system 110 for processing by manager system 110. At block 1101, manager system 110 can be receiving and buffering the received satellite images. On completion of buffering block 1101, manager system 110 can proceed to encoding block 1102. At encoding block 1102, manager system 110 can encode one or more attribute of the spectral image, such as wavelength, bandwidth, timestamp, spectral reflectance, etc. The encoding can include linear and non-linear mathematical transformations for each attribute.

For encoding instances of an image, manager system 110 at block 1102 can tag one or more spectral channel of the image as a masked channel. Thus, after encoding an instance of an image with mask data, the encoded image can include one or more masked channel and one or more remaining channel that is not masked. At encoding block 1102, manager system 110 can replicate a received satellite spectral image M-1 times so that there are provided M instances of the received image. Manager system 110 at encoding block 1102 can encode the different instances of the received image differently with differentiated mask data, so that the mask data between the different instances of a certain captured image can be differentiated. Received image data received by manager system 110 responsively to the sending at block 1301 can be tagged with a region identifier that specifies the geospatial region represented by the image, as well as a timestamp that specifies a time of image collection. In one aspect, the masking by channel masking can be on a channel basis rather than on a pixel basis. Where a multi-pixel image is masked via column masking, each pixel forming the image can have one or more masked channel and one or more unmasked channel.

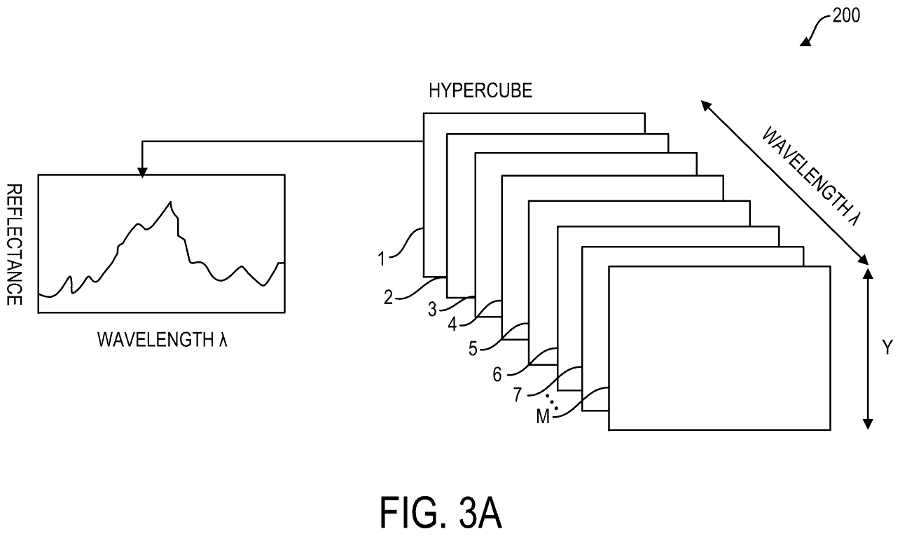

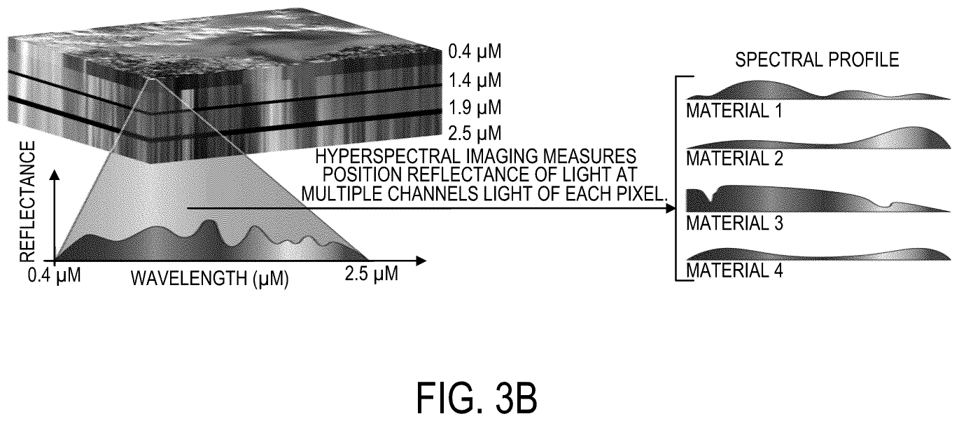

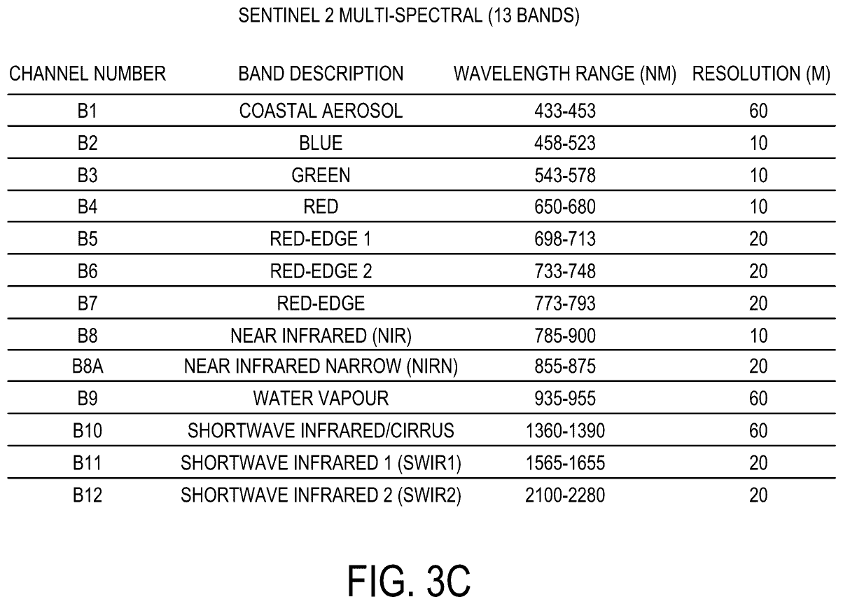

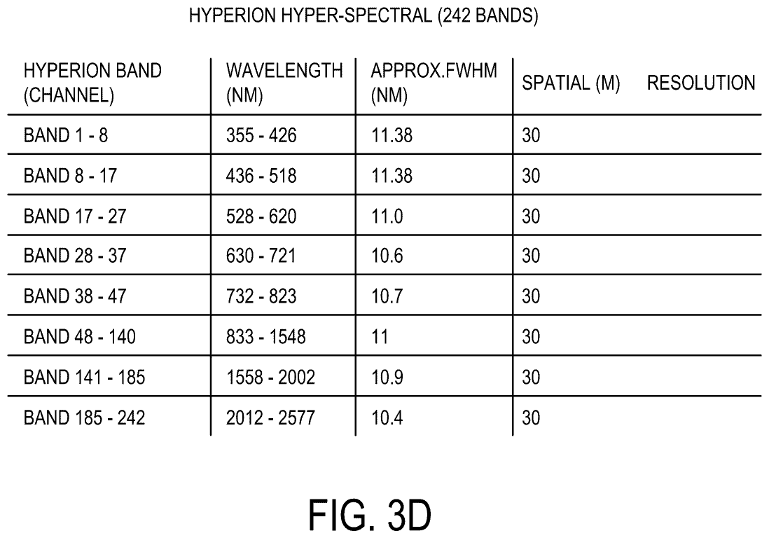

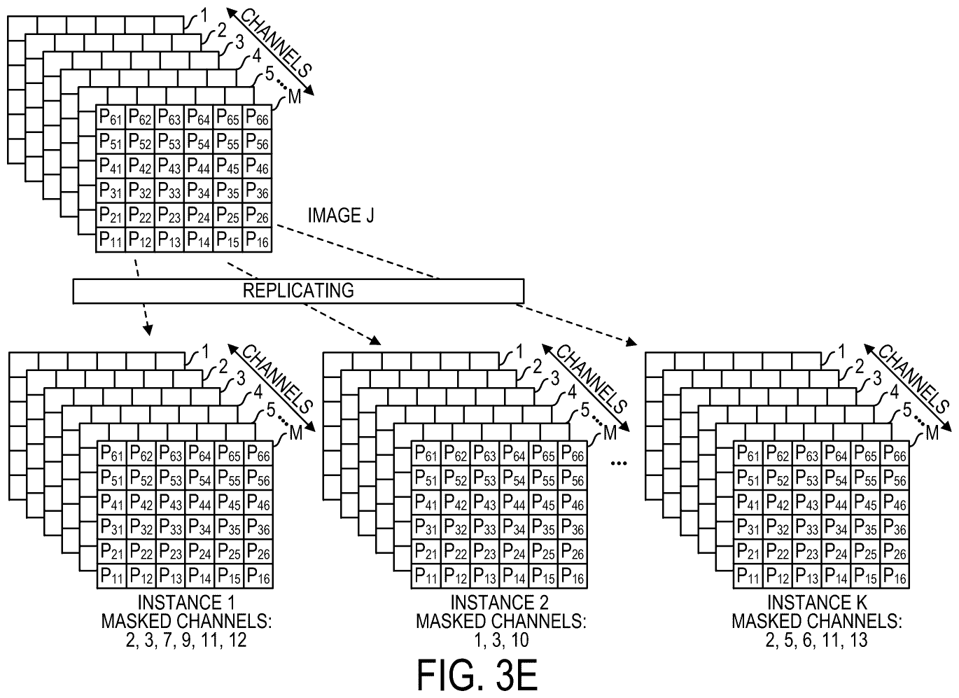

Manager system 110 performing spectral encoding at block 1102 is set forth in reference to FIGS. 3A-3E. Referring to FIG. 3A, FIG. 3A is a representation of spectral image data that can be produced by the satellite imaging system, such as satellite imaging system of satellite imaging systems 130A-130Z as shown in FIG. 1A. Referring to FIG. 3A. spectral image data output by a satellite imaging system of satellite imaging systems 130A-130Z can comprise a plurality of channels which can include, e.g., channels one to M as shown in FIG. 3A. In the case of a Sentinel 2 Multispectral image, M can be 13 channels (bands). In the case of a Hyperion Hyperspectral image, M can be 242 channels (bands). Referring to FIG. 3B, spectral image data output by a satellite imaging system of satellite imaging systems 130A-130Z can comprise a plurality of channels such that different materials subject to imaging can have different spectral profiles.

Attributes of the Sentinel 2 Multispectral image data format having 13 channels (bands) are depicted in FIG. 3C. Attributes of the Hyperion Hyperspectral format having 242 channels (bands) are depicted in FIG. 3D.

Manager system 110 for encoding spectral image data can encode the spectral image data so that one or more channel is encoded as a masked channel. Encoded as described, the encoded spectral image encoded with mask data can be used to train a predictive model. Training data for training a predictive model can include a training dataset that comprises an outcome associated to an input. The outcome data can be provided by imaging data of a masked channel of an encoded image. The input data can include image data of the remaining channels of the spectral image that are not subject to masking by the encoding. Trained as described with iterations of training data, the predictive model can learn relationships between channels of a spectral image.

Spectral images received by manager system 110 that are sent at block 1301 can be tagged with geospatial reference indicators and can be timestamped so that the time of each image collection by system 100 can be recorded.

Manager system 110 can be processing multiple images concurrently from multiple satellite imaging systems 130A-130Z. The satellite imaging systems 130A-130Z as shown in FIG. 1A can be deployed globally about the earth. In some embodiments, satellite imaging systems of satellite imaging systems 130A-130Z can include changing positions and can be configured so that regions represented by collected image data can be changing over time. Sent images sent at block 1301 can specify a geospatial identifier in the form of coordinates of the image that maps to a region identifier and/or can specify a region identifier that maps to coordinates of a represented area.

On completion of encoding block 1102, manager system 110 can proceed to training block 1103. At training block 1103, manager system 110 can perform training of one or more predictive model in dependence on the encoding performed by manager system 110 at block 1102 and in dependence on the sent image data sent at block 1301. The training algorithm can be a self-supervised algorithm in which training of a predictive model can be performed with use of unlabeled training data. Training in one embodiment can include randomly masking some of the spectral channels, calculating the loss and then, wherein a predictive model is neural network based, adjusting weights of the neural network.

In one embodiment, system 100 can include a foundation model architecture. A foundation model architecture can include a foundation model and one or more specific task model. Where system 100 features a foundation model architecture, manager system 110, on completion of training block 1103, can proceed to block 1104. At block 1104, manager system 110 can perform fine tuning training of an instance of a foundation model for production of a specific task model which specific task model can be further trained by fine tuning training.

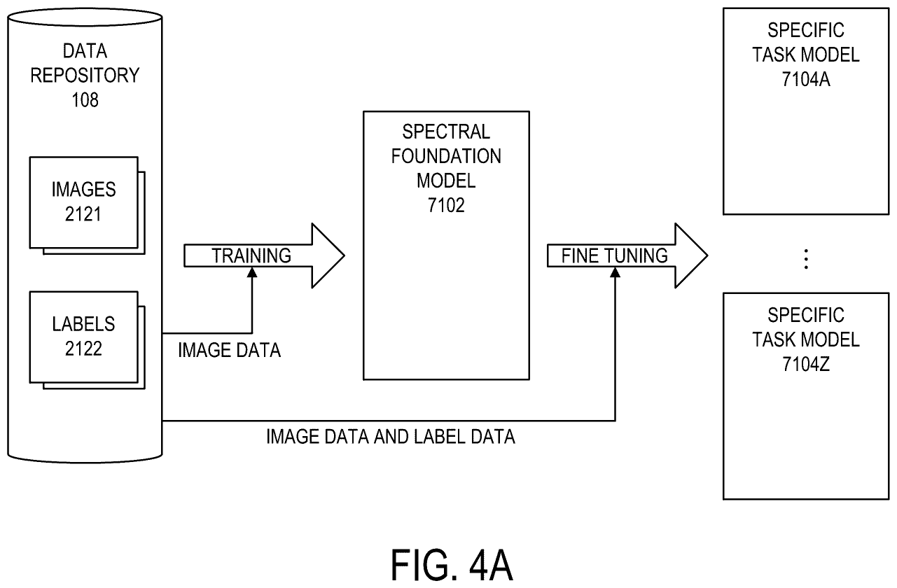

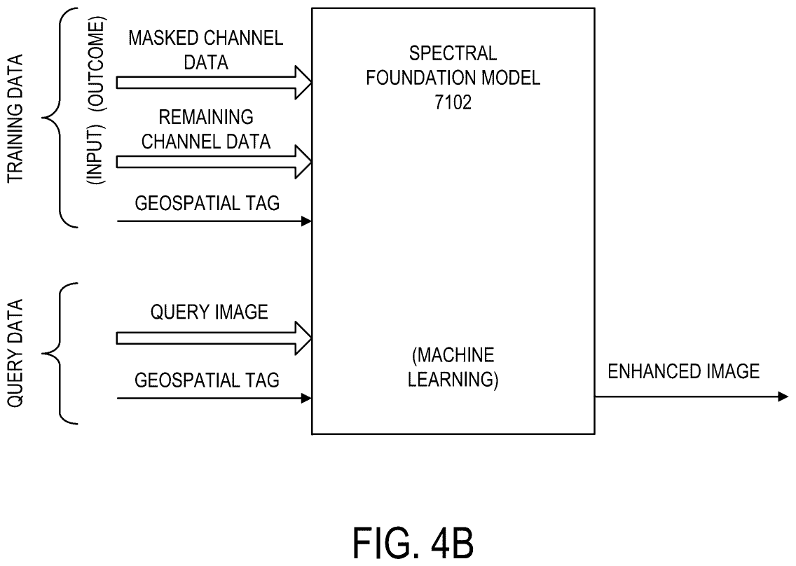

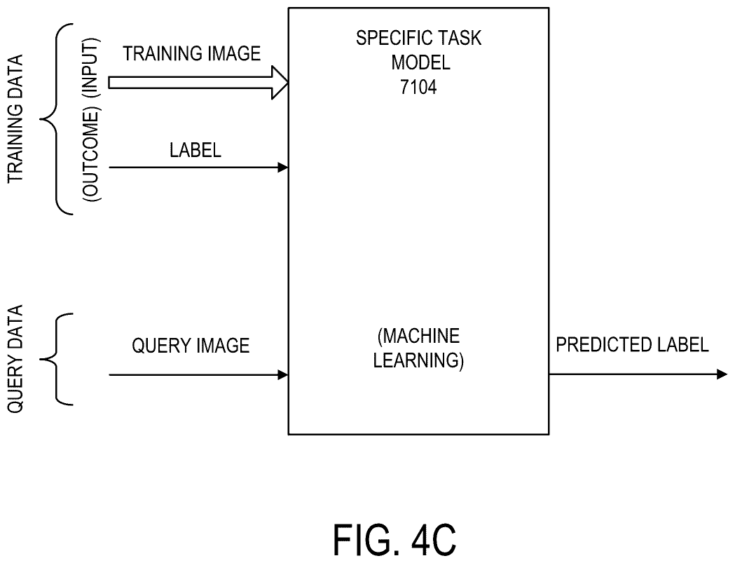

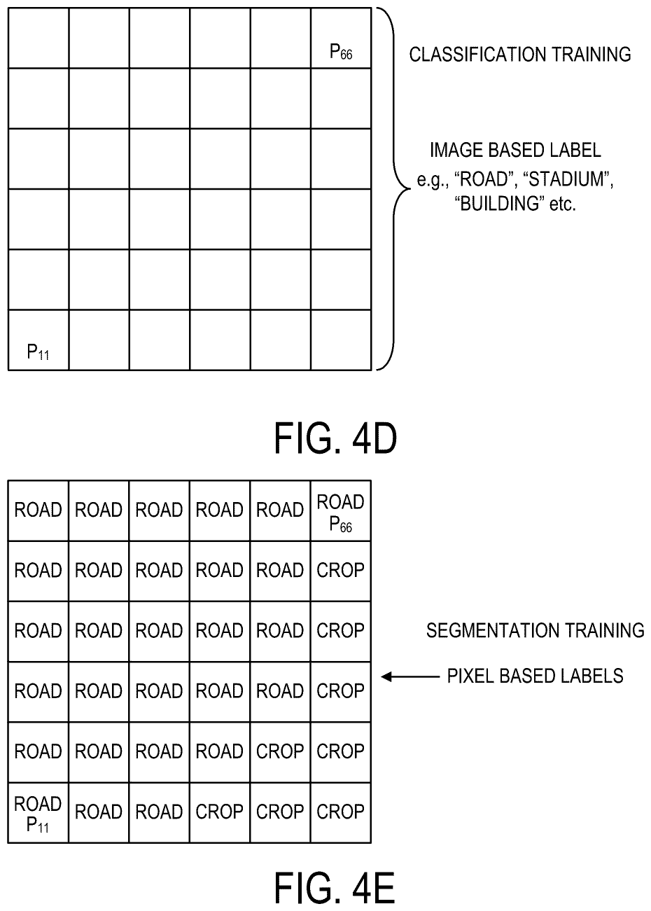

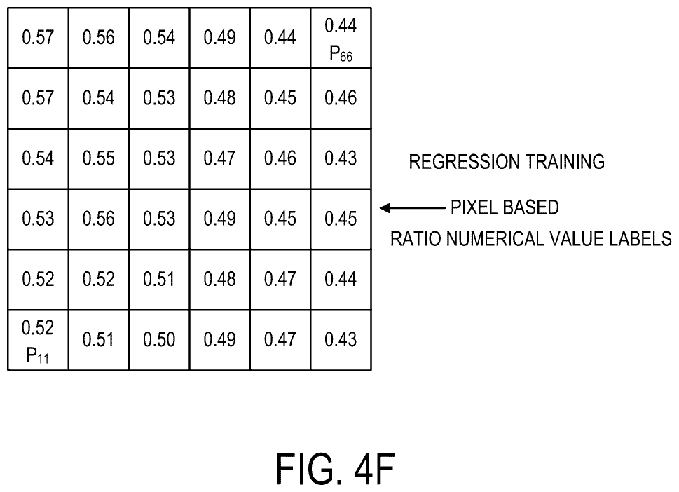

A predictive model architecture for manager system 110, according to one embodiment, is set forth in reference to FIG. 4A. Manager system 110 can include a predictive model provided by a spectral foundation model 7102, and a one more predictive model provided by specific task models 7104A to 7104Z.

According to the architecture depicted in FIG. 4A, foundation model 7102 can be trained with use of unlabeled training data and specific task model, 7104A to 7104Z can be trained with use of labeled training data. The described foundation model architecture comprising a division of training data types between foundation model 7102 and the specific task model 7104A to 7104Z, where foundation model 7102 can be provided and trained by use of unlabeled training data and specific task models 7104 can be provided and trained with labeled training data, can provide advantages. In one aspect, embodiments herein recognize that labeling training data can consume significant resources including time resources, and in some cases manual operation resources wherein labeling comprises manual labeling.

In one aspect, while automation of labeling can be performed, labeling can include manual labeling of historical image data with use of a user interface such as user interface 200 set forth in reference to FIG. 1B. In that foundation model 7102 can be trained without use of labeled training data, foundation model 7102 can be trained at high speed and thus, significant volumes of training data can be applied in a short time, leading to accuracy improvements of the foundation model 7102 over a limited training time. In one aspect, manager system 110 can be configured to include a pipeline that continuously trains foundation model 7102 with unlabeled training data on an ongoing basis received from data sources such as satellite imaging systems 130A to 130Z. The lack of labels associated to training data for training foundation model 7102 can facilitate training of foundation model 7102 at high speed with vast amounts of input training data and real time directly from a data source without interruption, e.g., interruption for purposes of applying labels to the input training data.

Labels that label image data for use in applying labeled training data for defining and further training of specific task models 7104A-7104Z can be obtained from a variety of sources. In one example, administrator users can use user interface 200 of FIG. 1B to define label data for image data. Instances of user interface 200 can include administrator users, e.g., of manager system 110, one or more of enterprise systems 140A-140Z, or other administrator users. Label data specified by an administrator user of an enterprise can be sent at block 1401 and manager system 110 can responsively store the received label data to labels area 2122. Contemporaneously, an administrator user of manager system 110 can define additional label data for storage into labels area 2122. When manager system 110 stores label data to labels area 2122, the labels can specify a timestamp of archiving, as well as an identifier of an image stored in images area 2121 associated to the labels. At iterations of fine tuning block 1104, manager system 110 can query the timestamps associated with label data stored in labels area 2122 and can appropriately apply, based on a result of the timestamp query, any newly labeled images as training data for training specific task models 7104A-7104Z.

Foundation model 7102, in one embodiment, can be trained using unlabeled datasets saving time and expense associated with manually labeling each item in a large collection of training data. In the specific embodiment of FIG. 4A, foundation model 7102 can be trained with use of spectrally masked training data in which training data comprises masked channel information.

Specific task models 7104A to 7104Z can be provided by fine tuning training of an instance of foundation model 7102 and further training of a defined specific task model. In the described embodiment of FIG. 4A, specific task models 7104A to 7104Z produced by fine tuning training of an instance of foundation model 7102 can be adapted to perform specific tasks. For providing of a specific task model of specific task model 7104A-7104Z for performance of a specific task, an instance of foundation model 7102 can be trained with labeled training data by use of fine tuning training to define a specific task model, which specific task model can be subject to further training by fine tuning training. On training the instance of foundation model for a performance of a specific task using labeled training data, the trained predictive model defines a specific task model of specific task models 7104A-7104Z, which specific task model can be subject to iterative continued training according to a fine tuning training method. Embodiments herein recognize that when an instance of foundation model 7102 is subject to fine tuning training using labeled training data, the defined specific task model 7104 defined by the fine tuning training will have been trained for performance of spectral enhancement as set forth herein. Accordingly, query images input the specific task model 7104 for output of one or more prediction label can be spectrally enhanced by the specific task model 7104.

Training data for training foundation model 7102 as set forth herein can include training data iterations that comprise (a) image data of unmasked channels of an input image applied to as an input to foundation model 7102 in combination with (b) image data of a masked portion of the input image applied as a comparison outcome associated to the applied input. Thus, input unmasked imaged data can be trained on image data of masked channels so that foundation model learns a relationship between unmasked channels and masked channels. Foundation model 7102, in one embodiment, can be provided by a neural network. Configured as described with training data as set forth in the described embodiment, training of foundation model 7102 can result in weights of foundation model 7102 being adjusted on application of each iteration of training data. The described training data for training foundation model 7102 can be regarded to be unlabeled training data given that the process is absent of applying labels to any training data, and the described process for training spectral foundation model 7102 can be regarded to be self-supervised, given that input training image data input into foundation model 7102 can be trained on an observation obtained from received image data used for training (the image data of the masked portion of an training image).

Manager system 110 performing training of a predictive model at block 1103 in dependence on encoded image data encoded at block 1102 is as set forth in reference to FIG. 4B depicting a spectral predictive model providing spectral foundation model 7102. Spectral foundation model 7102 can be trained with iterations of training data. Training data can include data of an encoded spectral image received from a satellite imaging system which has been encoded and specifying one or more channel of a received image as a masked channel. Iterations of training data for training spectral foundation model 7102 can include image data of a masked channel data defining an outcome and remaining channel data that is not masked (defining an input). Once an image instance is masked by the encoding at block 1102, the image data of the spectrally masked portion of the image can be treated as an outcome of a training dataset which dataset in addition to outcome training data includes input training data provided by remaining image data of an encoded image that is not masked. Accordingly, unmasked channel image data of an image input into foundation model 7102 can be trained on the outcome of image data of masked channels of the image so that foundation model 7102 learns the relationship between unmasked channels and masked channels. Trained as described, foundation model 7102 can predict missing spectral information of any input query image.

Manager system 110 performing training at block 1103 can include manager system 110 training spectral foundation model 7102 in dependence on encoded mask data encoded at encoding block 1102. For training spectral foundation model 7102 as shown in FIG. 3B, iterations of training data for training spectral foundation model 7102 can include (a) information of image data of a masked one or more spectral channel of an image instance (defining outcome), (b) information of image data of remaining (unmasked) channels of the image instance, and (c) a geospatial tag of the image instance. Where there are produced K masked instances of certain spectral image, manager system 110 can apply K sets of training data for that certain spectral image and manager system 110 at a current iteration of training block 1103 can have previously performed the described training process for L spectral images where L can include, e.g., tens, hundreds, thousands, millions or more training images.

By training of a spectral foundation model 7102 according to the described process, spectral foundation model 7102 learns a relationship pattern between different spectral channels of an image representing a geospatial region. Trained as described, unmasked channel image data of an image input into foundation model 7102 can be trained on the outcome of image data of masked channels of the image so that spectral foundation model 7102 learns the relationship between unmasked channels and masked channels. Trained as described, spectral foundation model 7102 can predict missing spectral information of any input query image.

Manager system 110 at encoding block 1102 can encode K instances of the received image and can encode each of the instances differently, marking different channels as being masked for each instance. For example, manager system 110 can selectively encode channel 1 as a masked channel of a first instance of a certain image and can encode channel 2 as a masked channel of a second instance of the certain image, and so on. For each instance of the received certain image, manager system 110 can apply an iteration of training data in the manner described with reference to spectral foundation model 7102, wherein image data of masked channels can be applied as outcome training data and wherein image data of remaining channels that are not masked can be applied as input training data associated to the outcome training data. In one embodiment, spectral foundation model 7102 can be provided by a neural network. Training in one embodiment can include calculating loss with the input and outcome training data applied as described, and adjusting weights of the neural network in dependence on the loss.

Training of spectral foundation model 7102 according to one embodiment is described further in reference to FIG. 3E. Referring to FIG. 3E, a received image, image J, can be subject to replication so that there are provided K instances of image J. Each image can include M channels, 1 through M, and each channel can include and X×Y pixel array, as set forth herein, defined by pixel positions. Pixel positions P11-P66 are shown in FIG. 3E. However, the number of pixels can be scaled down or up, e.g., to 10+x10+, 100+x100+, or higher to megapixel scale. The resolution of the pixelated image can range from less than about 1 m per pixel to greater than about 30 m per pixel.

Random masking is depicted in FIG. 3E wherein the received image can be a Sentinel-2 image having 13 channels (bands). In the image instance 1 of image J, channels 2, 3, 7, 9, 11, and 12 are masked. In the image instance 2 of image J, channels 1, 3, and 11 are masked. In the image instance K of image J, channels 2, 5, 6, 11, and 13 are masked. For each instance of the received certain image, manager system 110 can apply an iteration of training data in the manner described with reference to spectral foundation model 7102, wherein image data of masked channels can be applied as outcome training data and wherein image data of remaining channels that are not masked can be applied as input training data associated to the outcome training data. Where foundation model 7102 is provided as a neural network, foundation model 7102 training can include calculating loss with the input and outcome training data applied as described, and adjusting weights of the neural network in dependence on the loss.

Spectral masking through a succession of images is described with reference to Table A.

TABLE A
(Random spectral masking)

| | Image instance 1 | Image instance 2 | | |
|---|---|---|---|---|
| Image | masked channels | masked channels | . . . | Image instance K |
| J | 2, 3, 7, 9, | 1, 3, 10 | . . . | 2, 5, 6, 11, 13 |
| | 11, 12 | | | |
| J + 1 | 1, 5, 8, 13 | 2, 4, 9, 11, | . . . | 3, 4, 6, 8, |
| | | 12, 13 | | 9, 10, 12 |
| J + 2 | 2, 9, 11, 13 | 4, 5, 6, 10 | . . . | 3, 7, 9, 12 |
| . . . | . . . | . . . | . . . | . . . |

In another use case, manager system 110 can train spectral foundation model 7102 according to fixed pattern masking. Table B depicts applications of spectral masks to image instances according to a fixed pattern masking scheme.

TABLE B
(Fixed pattern spectral masking)

| | Image instance 1 | Image instance 2 | Image instance 3 | Image instance 4 | |
|---|---|---|---|---|---|
| Image | masked channels | masked channels | masked channels | masked channels | . . . |
| J | 1, 2, 3, 10, 11, 12 | 4, 5, 6, 7, 8, 9 | 1, 2, 3, 10, 11 | 5, 6, 7, 8, 9 | . . . |
| J + 1 | 1, 2, 3, 10, 11, 12 | 4, 5, 6, 7, 8, 9 | 1, 2, 3, 10, 11 | 5, 6, 7, 8, 9 | . . . |
| J + 2 | 1, 2, 3, 10, 11, 12 | 4, 5, 6, 7, 8, 9 | 1, 2, 3, 10, 11 | 5, 6, 7, 8, 9 | . . . |
| . . . | . . . | . . . | . . . | . . . | . . . |

Another fixed pattern masking scheme is set forth in reference to Table C.

TABLE C
(Fixed pattern spectral masking)

| | Image | Image | Image | Image | Image | |
|---|---|---|---|---|---|---|
| | instance | instance | instance | instance | instance | |
| | 1 | 2 | 3 | 4 | 5 | |
| | masked | masked | masked | masked | masked | |
| Image | channels | channels | channels | channels | channels | . . . |
| J | 1, 3, 5 | 2, 4, 6 | 7, 9, 11 | 8, 10, 12 | 13, 2, 4 | . . . |
| J + 1 | 1, 3, 5 | 2, 4, 6 | 7, 9, 11 | 8, 10, 12 | 13, 2, 4 | . . . |
| J + 2 | 1, 3, 5 | 2, 4, 6 | 7, 9, 11 | 8, 10, 12 | 13, 2, 4 | . . . |
| . . . | . . . | . . . | . . . | . . . | . . . | . . . |

Once trained, spectral foundation model 7102 can be configured to respond to query data. Query data for querying foundation model 7102 can include a received spectral image. On being queried with a received spectral image defining a query image, foundation model 7102 can predict missing spectral data of the image to provide an enhanced spectral image. Embodiments herein recognize that received spectral image data can include imperfections, e.g., noise such as random noise and/or fixed pattern noise. By learning of relationships between spectral channels of received images, foundation model 7102 can be trained to predict missing information of collected image data attributable, e.g., to noise, and can output prediction data specifying missing pixel information processable to transform an input query image into an enhanced image. The enhanced image can define missing information of an input query image (enhanced image minus query image equals missing image information).

Addition aspects of training spectral foundation model 7102 in one embodiment are set forth in Table D.

TABLE D
Preparing training data: The training data can include spectral images with each image having a finite
number of channels. The image information comprising spectral information, time stamp, resolutions
can be stored as metadata. The images can be divided into smaller images called patches.
Data Transformation/tokenization: Each image can be divided into non-overlapping patches. Each
patch can be transformed into a numerical vector of specified length. The vector can include a patch
embedding, position encoding and spectral encoding. Patch embedding can linearly project a 2D
image into a single vector. Position encoding can encode the information on where each patch lies in
the larger image to make the embeddings position aware. The spectral encoding can encode the spectral
information into a high-dimensional space for each patch to make the embeddings spectrally aware. A
single vector can be constructed combining the outputs from the described patch embedding, position
encoding and spectral encoding operations.
Self-supervised training through spectral channel masking: Training can take as an input the number of
channels or percentage of channels per image to be masked. These channels can be selected randomly.
The model can be iteratively trained on the unmasked channels by feeding with the sequence of tokens
for the unmasked channels. The trained model in each iteration/epoch can predict the unmasked tokens
which are compared against the original image tokens/images. The training loss can be calculated as
the difference between predictions and actual tokens.
Stopping criterion: The training can stop when the pre-specified number of epochs are reached, or on a
performance condition.

Table E hereinbelow sets forth example program code for performing spectral embeddings on a received image.

TABLE E

```
  def get_spectral_embeddings(embed_dim, dummy):
    “‘’”
    spectral embeddings for Sentinel −2 multi-spectral data
    “‘’”
    cw = np.array([442, 492, 559, 664, 704, 740, 782, 832,
    864, 945, 1373, 1613, 2202])
    bw = np.array([21, 66, 36, 31, 15, 15, 20, 106, 21, 20,
    31, 92, 180])
    wl_lb = cw−bw
    wl_ub = cw+bw
    wlr=np.linspace(wl_lb, wl_ub, embed_dim).transpose( )
    xa=np.min(wlr)
    xb=np.max(wlr)
    xc=(xa+xb)/(xb−xa)
    emb_spect=(wlr−xa/(xb−xa) # Transformation to [0, 1]
    if dummy:
      temp=np.linspace(0, 1, embed_dim)
      mbspec=np.vstack([emb_spect,temp]
return emb_spect
```

Referring to Table B, the spectral encoding can linearly transform the spectral information of Sentinel-2 data into a vector of specified length within a range of [−1,1]. The vector with spectral information can be concatenated with the image pixel values, and other values to make a larger vector, also called as token. As set forth herein, all can be scaled to [−1,1] so that the vector is normalized. Vector normalization can help in calculating attention in transformers where transformer architecture is employed and can assure that all portions of the vector are treated equally.

Encoding of received image data at block 1102 can include fixed channel masking or random channel masking. Table F hereinbelow sets forth example program code for performing spectral embeddings on a received image for masking selected channels.

```
TABLE F
def random_spectral_masking(self, x, nb_mask, nbands):
  #Perform random selection band masking. x: [N, L, D], sequence
  N, L, D = x.shape # batch, length, dim
  # lists to just store the indices
  ids_shuffle = [ ]
  ids_restore = [ ]
  #create sequence of band no's and random select no of bands to be masked
  seq=list(range(0,nbands))
  unique_rand_nums = np.random.choice(np.arange(0, nbands), nb_mask, replace=False)
  indremove=unique_rand_nums.tolist( )
  indkeep+list(set(seq) − set(indremove))
  #lists to collect the indices of masked and un-masked/keep bands
  xkeep=[ ]
  xrem=[ ]
  Lt=int(L/nb_mask)
  for i in indkeep: xkeep.extend(list(range(i*Lt,(i+1)*Lt,1)))
  for i in indremove: xrem.extend(list(range(i*Lt, (i+1)*Lt, 1)))
  # generate the binary mask: 0 is keep, 1 is remove
  mask = torch.ones([N, L], device=x.device)
  mask[:,xkeep] 0 # 0 means this token is not masked
  ids_keep = ids_shuffle[:, :len(xkeep)]
  ids_keep[:,:len(xkeep)] = torch.LongTensor(xkeep)
  #x_masked is size of non masked tokens
  x_masked = torch.gather(x, dim=1, indexids_keep.unsqueeze(−1).repeat(1, 1, D))
  # unshuffle to get the binary mask
  mask = torch.gather(mask, dim1, index=ids_restore)
  x_masked = torch.gather(x, dim=1, index=ids_keep.unsqueeze(−1).repeat(1, 1, D))
  return x-masked, mask, ids_restore
```

Referring to Table F, a spectral masking process can mask a spectral channel within input data/tokens and return the masked indices to recover the masked data during a fine tuning training process performed subsequently to training of spectral foundation model 7102.

Once spectral foundation model 7102 is trained, an instance of spectral foundation model 7102 can be subject to fine tuning training for providing of a task specific model. Task specific models produced herein can include task specific models for classification, segmentation, and regression.

Training of a task specific model can take task-specific labeled data and update weights of the model. The fine tuning procedure can include a supervised learning algorithm that minimizes the differences between the known labels and model predictions. For providing a task specific model 7104 as shown in FIG. 4C, labeled image data can be applied to an instance of a trained foundation model 7102 (FIG. 4B) so that the trained model defines task specific model 7104, and the task specific model can be further trained with labeled image data.

Various examples of specific task models are now described. In one embodiment, specific task model 7104A (FIG. 4A) can be an image classification specific task model trained for the specific task of classifying an image. An iteration of training data for training image classification specific task model 7104A can include an image defined by multiple pixels (a training input) associated with a ground truth defining label (the training outcome) that labels the image defined by multiple pixels (pixel positions). For example, a first image defined by multiple pixels can be labeled with the label “road” and a second image defined by multiple pixels can be labeled with the label “stadium” and a third image can be labeled with the label “building” and so on. Trained as described, input image data input into specific task model 7104A can be trained on label data. As a result, specific task model 7104A learns relationships between input image data and applied labels.

For training a “classification” specific task model, manager system 110 as set forth in FIG. 4D can apply training labels defining ground truth labels on a per-image basis, and the applied labels applied to a multi-pixel training image be provided by image classification labels that specify the classification of an object in an area represented by a set of pixels defining a multi-pixel image. In the example of FIG. 4D, a first multi-pixel training image can represent a road, and accordingly, an applied image label can be the label “road”. A second multi-pixel training image can represent a stadium, and accordingly, an applied image label can be the label “stadium”. A third multi-pixel training image can represent a building, and accordingly, an applied image label can be the label “building”.

When training a “classification” specific task model with use of M/HS images, manager system 110 can apply the described labeled training dataset M times, one for each channel (13 channels or 242 channels) defining the training image, and can apply the same label, e.g., “stadium” for the respective X×Y pixel array associated to each of the M channels defining the training image. When specific task model 7104A trained according to FIG. 4D is queried with a query image, the specific task model 7104A can output a multi-pixel image associated label, specifying, e.g., “stadium” or “building” processable by examining of the label for recognition of a condition, e.g., whether a stadium is present.

In one embodiment, specific task model 7104B (FIG. 4A) can be a “segmentation” specific task model trained for the specific task of image segmentation. An iteration of training data for training a segmentation specific task model 7104B can include a set of pixels defining an image (a training input) associated respective labels associated to the respective pixels (training outcome). For example, a first pixel of an image can be labeled with the label “crop” and a second pixel of an image can be labeled with the label “road” where a training image represents a scene having a roadway bordering a crop. Trained as described, input image data input into specific task model 7104B can be trained on label data. As a result, specific task model 7104B learns relationships between input image data and applied labels. Trained as described, specific task model 7104B is able to output predictions as to the predicted label associated to each respective pixel of an input query image.

For training a “segmentation” specific task model, manager system 110 as set forth in FIG. 4E can apply training labels defining ground truth labels on a per-pixel basis, and the applied labels applied to the various pixels can be provided by category labels that specify the category of object in an area represented by a pixel. In the example of FIG. 4E, an area represented by a first pixel can be a “road”, and an area represented by a second pixel can be a “crop”. Additional examples of per-pixel labels can be, e.g., “forest”, “building”, “pond”, “human (person)”, “fire” and the like. Trained as described, the trained specific task model is able to learn relationships between the input image data and the labels, and once sufficiently trained, is able to return predictions as to the relationships trained on. On query of a trained “segmentation” specific task model with a query image, the trained specific task model can output with query image with prediction labels attached to each pixel of the output image, wherein the prediction label specifies the predicted object that is represented by each pixel defining the query image.

When training a “segmentation” specific task model with use of M/HS images, manager system 110 can apply the described training dataset M times, one for each channel (13 or 242) defining the training image, and can apply the same labels for the pixel array pixels associated to each respective channel. When specific task model 7104B trained according to FIG. 4E is queried with a query image, the specific task model 7104B can output pixel specific prediction labels, e.g., one label per pixel of the query image. Manager system 110 can examine the pixel specific prediction labels for recognition of a condition, e.g., whether a crowd is present.

In one embodiment, specific task model 7104C (FIG. 4A) can be a “regression” specific task model trained for the specific task of predicting a relational attribute. An iteration of training data for training a regression specific task model 7104C can be a set of pixels defining an image (a training input) associated to respective labels associated to the respective pixels (training outcome). The labels can be applied on a per pixel basis and can include real numbers. For example, a first one or more pixel of an image can be labeled with the label “0.43” and a second one or more pixel of an image can be labeled with the label “0.45” where a training image represents a scene such as a landscape captured with use of a satellite imaging system. The real number labels can represent degree of inclusion of a substance within an area represented by a pixel according to one embodiment. Trained as described, input image data input into specific task model 7104C can be trained on label data. As a result, specific task model 7104C can learn relationships between input image data and applied labels. Trained as described, specific task model 7104C is able to output predictions as to the predicted label associated to each respective pixel of an input query image.

For training a “regression” specific task model, manager system 110 as set forth in FIG. 4F can apply training labels defining ground truth labels on a per-pixel basis, and the applied labels applied to the various pixels can be provided by real numbers, which in one embodiment can be provided by ratio numerical value labels. The real number labels in one embodiment can specify a characteristic of an area represented by a pixel that is expressed by a real number indicating a scale of relevant amount or intensity. The real number values can represent, e.g., the degree of inclusion of carbon within an area represented by a pixel of a training image, the degree of inclusion of nitrogen within an area represented by a pixel of a training image, the degree of inclusion of calcium within an area represented by a pixel of a training image, the degree of inclusion of metal within an area represented by a pixel of a training image, the degree of inclusion of any certain substance within an area represented by a pixel of a training image, the degree of inclusion of any certain chemical within an area represented by a pixel of a training image, the degree of inclusion of metal within an area represented by a pixel of a training image, the degree of inclusion of any certain metal within an area represented by a pixel of a training image, the degree of inclusion of water within an area represented by a pixel of a training image, the degree of inclusion of ice within an area represented by a pixel of a training image, a pH level of an area represented by a pixel of a training image, and the like. Trained as described, the trained specific task model is able to learn relationships between the input image data and the labels, and once sufficiently trained, is able to return predictions as to the relationships trained on. Manager system 110 can train a new specific task model in accordance with the described specific task model for every characteristic for which returned predictions are targeted.

On query of a trained “regression” specific task model with a query image, the trained specific task model can output with query image with prediction labels attached to each pixel of the output image, wherein the prediction label specifies the predicted scale of relevant amount or intensity associated to each pixel in reference to the characteristic for which the “regression” specific task model was trained. It will be seen that, a “regression” specific task model may be particularly useful in detecting changed conditions, e.g., as caused by precipitation or heat. In one particular example, a “regression” specific task model, e.g. one trained with use of “degree of inclusion of water” or degree of inclusion of ice” labeled training data as set forth herein may be selected for detection of snowfall.

When training a “regression” specific task model, with use of M/HS images, manager system 110 can apply the described training dataset M times, one for each channel (13 or 242) defining the training image, and can apply the same labels for the pixel array pixels associated to each respective channel.

When specific task model 7104B trained according to FIG. 4F is queried with a query image, the specific task model 7104C can output pixel specific prediction labels, e.g., one label per pixel of the query image. Manager system 110 can examine the pixel specific prediction labels for recognition of a condition, e.g., whether there has been a snowfall.

FIG. 4C illustrates manager system 110 training one or more specific task model depicted as specific task model 7104 representative of specific task model 7104A, specific task model 7104B or another type of specific task model. For training specific task model 7104, manager system 110 can perform fine tuning training using labeled training data to further train an instance of spectral foundation model 7102 (FIG. 4C) using specific task labeled training data to define specific task model 7104, and can continue to train the defined specific task model 7104 by application of labeled training data thereto.

In one example, manager system 110 training specific task model 7104 for a specific task can include manager system 110 training specific task model 7104 with specific task training data that trains an instance spectral foundation model 7102 for defining a specific task model 7104 that can be queried to output prediction data processible by examination of the prediction data to recognize a specified condition. As illustrated in FIG. 4C, training of specific task model 7104 to perform a specific task can include iterations of training data including training outcome data and training input data. Referring to FIG. 4C, outcome data can be the known condition specified by a label associated to a training image and the training input data can be the training image (the image in which a known condition specified by a label is present). Trained as described specific task model 7014 is able to output prediction data processable by examination of the prediction data to recognize a condition on receipt of query data, which query data can be provided by a query image.

Embodiments herein recognize that because task specific model 7104 can be provided by fine tuning training of an instance of foundation model 7102, specific task model 7104 can be configured to perform spectral enhancement predictions in the manner of spectral foundation model 7102. As such, the application of a query image to specific task model 7104 can result in the output of an enhancement of a query image defining an enhanced image.

Additional aspects of training a classification specific task model for performing image classification in one embodiment are set forth in Table G.

TABLE G
Data preparation: The training data can include spectral images with each image having a finite number
of channels. The image metadata can comprise image labels, i.e., which class the image belongs to,
spectral information, time stamp, resolutions, etc. Some portion of the data is kept as test data. The
images can be divided into smaller images called patches.
Data transformation/Tokenization: Same as in Pre-training
Modifying model architecture and initializing the model: The pre-trained model can be loaded and
decoder layers can be removed from the model and additional output layers known as a classification
head matching the number of classes can be attached. The modified network weights can be initialized
from the pre-trained model weights, called a checkpoint, except for the additional layers with learnable
weights.
Supervised training with labelled images: Some or all the weights of the model initialized with a pre-
trained model can be freezed and the weights for additional layers can be learned during the training.
The accuracy metrices can be calculated on the test data by predicted class label on the test data and the
actual class label.
Stopping criterion: The training can stop when the pre-specified number of epochs are reached, or
when performance condition is met.

Additional aspects of training segmentation specific task model 7104B for image segmentation in one embodiment are set forth in Table H.

TABLE H
Data preparation: The training data can include spectral images with each image having finite number
of channels. The image metadata can include an image mask with pixel-wise labels, spectral
information, time stamp, resolutions, etc. Some portion of the data can be maintained as test data. The
images can be divided into smaller images called patches.
Data transformation/Tokenization: Same as in Pre-training
Modifying model architecture and initializing the model: The pre-trained model can be loaded and
additional MLP layers can be attached by replacing the decoder network. The modified network
weights can be initialized from the pre-trained model weights, called checkpoint, except for additional
layers with learnable weights.
Supervised training with image mask: Some or all the weights of the model initialized with pre-trained
model can be freezed and the weights for additional layers can be learned during the training. The
accuracy metrices can be calculated on the test data by predicted pixel-wise labels on the test data and
the actual label.
Stopping criterion: The training can stop when the pre-specified number of epochs are reached, or
when performance condition is met.

On completion of training block 1103 and/or fine tuning training block 1104, manager system 110 can proceed to validating block 1105. At validating block 1105, manager system 110 can perform validating of a trained spectral foundation model 7102 trained at block 1103. In performing validating block 1105, manager system 110 can test the trained spectral foundation model 7102 to determine whether the trained predictive model is performing satisfactorily for respective geospatial regions being serviced by the predictive model.

Manager system 110 at validating block 1105, in one embodiment, can perform testing of trained spectral foundation model 7102 across various geospatial regions to determine whether the trained spectral foundation model 7102 is ready for deployment for servicing those geospatial regions. Manager system 110 performing validating process 113 can test a trained predictive model to determine whether the trained predictive model exhibits a threshold satisfying level of performance. Manager system 110 performing validating process 113 can test a trained predictive model using holdout data. For example, manager system 110 can collect a test image and can encode the test image so that a subset of data defining the test image is held out and tagged as holdout data. For testing trained spectral foundation model 7102, the remaining data defining the test image that is not held out can be applied as query data along with a geospatial region identifier. Manager system 110 can examine a result of the test query using the holdout data. Manager system 110 can compare predicted missing data on being queried with remaining data and manager system 110 can compare the predicted missing image data (defined by an output enhanced image) to the holdout data (ground truth) in order to determine an accuracy performance parameter value of the predictive model for a specified geospatial region. At subsequent iterations of validating block 1105, as training of spectral foundation model 7102 becomes more advanced, manager system 110 can validate spectral foundation model 7102 for servicing new geospatial regions.

Manager system 110 at validating block 1105, in one embodiment, can perform testing of trained spectral foundation model 7102 without reference to geospatial region identifiers to determine whether the trained spectral foundation model 7102 is ready for deployment for servicing those geospatial regions. In one embodiment, spectral relationships between channels can be expected to be consistent across regions (which itself can be validated) and in such embodiments, validating can be performed on a general basis rather than on a region by region basis.

Manager system 110 at validating block 1105 can validate specific task models 7104A-7104Z. Manager system 110 at validating block 1105 for validating specific task models 7104A-7104Z can apply as query images multiple test images (having known image) associated to multiple different geospatial regions being serviced by manager system 110, and compare output predictions to the ground truth label data. Manager system 110 can aggregate, e.g., average accuracy test results resulting from each test image query and comparison against holdout (ground truth) data. At subsequent iterations of validating block 1105, manager system 110 can validate the specific task models 7104A-7104Z for additional geospatial regions. In one embodiment, specific task models 7104A-7104Z can be validated on a general basis, rather than on a region by region basis.

On completion of validating block 1105, manager system 110 can proceed to update registry block 1106. Manager system 110 at update registry block 1106 can update registry 2124 to specify new geospatial regions for which spectral foundation model 7102 and/or specific task models 7104A-7104Z have been validated at block 1105.

On completion of update registry block 1106, manager system 110 can proceed to query image select block 1107. At query image select block 1107, manager system 110 can determine whether a query image has been selected by a user, e.g., an administrator user associated to an enterprise or manager system 110. At block 1107, manager system 110 can be examining request data defined by an administrator user using user interface 200 as shown in FIG. 1B. Manager system 110 can be examining request data defined by an administrator user of an enterprise using an instance of user interface 200 as sent at block 1402 and request data defined by an administrator user of manager system using an instance of user interface 200.

Where manager system 110 determines at block 1107 that a query image has not been selected, manager system 110 can return to a stage preceding block 1101 and can iteratively perform the loop of blocks 1101-1107 until a query image is selected. On the determination at block 1107 that a query image has been selected, manager system 110 can proceed to block 1108 to apply the query image to the selected target model in accordance with the user defined request data. In one embodiment, the loop of blocks 1101-1107 can continue iteratively independent of whether a query image selected. That is, manager system 110 can branch to blocks 1108-1111 while continuing to perform the loop of blocks 1101-1107.

At block 1108, manager system 110 can perform querying a selected target model in accordance with the request data and examining of an output from the target model from the querying. In some use cases, request data can specify actions to be associated to recognized conditions. In such use cases, the examining can include examining to determine that a condition has been recognized. Manager system 110 on completion of block 1108 can proceed to block 1109 to return an action decision.

System 100 can be employed for a wide variety of uses that can be defined using user interface 200 of FIG. 1B. In one use case, a user may wish to employ system 100 for enhancement of an image independent of any recognition task. Embodiments herein recognize that received spectral image data can include imperfections, e.g., noise such as random noise and/or fixed pattern noise. By learning of relationships between spectral channels of received images, foundation model 7102 can be trained to predict missing spectral information of collected image data attributable, e.g., to noise, and manager system 110 can perform examining the predicted missing spectral information, and based on the examining, can transform an input query image into an enhanced image. Manager system 110 in transforming the query image can format the enhanced image in accordance with an image format, e.g., an image format according to M/HS. The enhanced image can define missing information of an input query image (enhanced image minus query image equals missing image information). Where foundation model 7102 is provided as a neural network, foundation model 7102 training can include calculating loss with the input and outcome training data applied as described, and adjusting weights of the neural network in dependence on the loss.

In such a use case, a user can select a query image of interest and can select spectral foundation model 7102 as the target model for query image submission. In such a use case, manager system 110 can store and archive in images area 2121 an enhanced image enhanced by querying foundation model 7102 with an input image. Accordingly, there is set forth herein, encoding, e.g., as set forth in reference to encoding block 1102, one or more instance of a received image with spectral mask data, wherein the spectral mask data specifies spectral information of the received image to be masked; training, e.g., as set forth in reference to block 1103 and/or block 1104, one or more predictive model in dependence on the encoding; querying, e.g., as set forth in block 1108, the one or more predictive model with a query image; and performing processing in dependence on an output from the querying. In the described use case, the output from the querying can include outputting prediction data specifying missing spectral information, and the performing processing can include examining the prediction data, and transforming the query image into a formatted spectrally enhanced image based on the examining. In such an embodiment, the performing processing can further include archiving the enhanced image.

In one use case, a user may wish to use system 100 for recognition of a condition where the condition is recognition of object, e.g., a stadium within an image. In such a use case, a user can select a query image of interest and a target model provided by an image classification specific task model 7104A. Manager system 110 can examine the prediction labels of the output query image for recognition of the specified condition, and can store the recognition result in models area 2123 associated to the model queried. Manager system 110 can later access the recognition result at later action decision block 1109. Accordingly, in such a use case, there is set forth herein, encoding, e.g., as set forth in reference to encoding block 1102, one or more instance of a received image with spectral mask data, wherein the spectral mask data specifies spectral information of the received image to be masked; training, e.g., as set forth in reference to block 1103 and/or block 1104, one or more predictive model in dependence on the encoding; querying, e.g., as set forth in block 1108, the one or more predictive model with a query image; and performing processing in dependence on an output from the querying, wherein the query image is provided by a multi-pixel query image, wherein the output from the querying includes a multi-pixel image associated prediction label attached to the multi-pixel query image (e.g., as set forth in referenced to FIG. 4D), and wherein the performing processing includes examining the multi-pixel image associated prediction label, and recognizing a condition based on the examining.

In another use case, a user may wish to use system 100 for recognition of a changed condition where the changed condition is a crowd formation. In such a use case, a user can select as query image data an ongoing succession of current images (most recently collected) currently being buffered and can select for querying a “segmentation” specific task model trained with per-pixel training labels that include “person” training labels as set forth herein. Manager system 110 can examine the prediction labels of the output query image for recognition of the specified condition, and can store the recognition result in models area 2123 associated to the model queried. Manager system 110 can later access the recognition result at later action decision block 1109.

In another use case, a user may wish to use system 100 for recognition of a changed condition. In such a use case, the user may find a “regression” or perhaps a “segmentation” specific task model suitable for use, and can select a model from models area 2123 for querying. In one example, the changed condition can be snowfall, which might be detected with use of “regression” specific task model trained for detection of the presence of a snowfall indicating substance, e.g. water or ice as set forth herein. In such a use case, a user can select as query image data an ongoing succession of current images (most recently collected) currently being buffered. Manager system 110 can examine the prediction labels of the output query image for recognition of the specified condition, and can store the recognition result in models area 2123 associated to the model queried. Manager system 110 can later access the recognition result at later action decision block 1109.

Actions associated to recognized conditions can also be specified by a user with use of user interface 200. These additional selections specifying, e.g., target model(s), recognition conditions, actions, can be passed with request data sent at block 1402.

Continuing with the stadium example, a user can select a first specific task model for recognition of a stadium, and then a second specific task model for recognition of crowd formation. As set forth herein, such specific task models can be provided by subjecting an instance of spectral foundation model 7102 (trained for image enhancement with use of spectral mask training) to fine tuning label based training, and further training the defined specific task models to fine tuning training. The user can also specify specific actions associated to the described recognition processing, e.g., the action of a vehicular robot transporting bandwidth enhancing telecommunication infrastructure to the detected location of the stadium responsively to the detection of crowd formation at the stadium. Accordingly, in reference to such an embodiment, there is set forth herein, encoding, e.g., as set forth in reference to encoding block 1102, one or more instance of a received image with spectral mask data, wherein the spectral mask data specifies spectral information of the received image to be masked; training, e.g., as set forth in reference to block 1103 and block 1104, one or more predictive model in dependence on the encoding; querying, e.g., as set forth in block 1108, the one or more predictive model with a query image; and performing processing in dependence on an output from the querying, wherein the training the one or more predictive model in dependence on the encoding includes training a foundation model 7102 using unlabeled training data in which spectral channels are masked, training an instance of the foundation model 7102 employing fine tuning training with use of labeled training data (e.g., as set forth in reference to FIG. 4E) to define a specific task model 7104, and further training the specific task model employing fine tuning training with use of additional labeled training data (e.g., as set forth in reference to FIG. 4E), wherein the output from the querying includes an output one or more prediction label, and wherein the performing processing includes examining the one or more prediction label, (e.g., as set forth in reference to FIG. 4E), recognizing a condition based on the examining (snowfall in the described example), and returning an action decision based on the recognizing. The performing processing in dependence on an output from the querying can include, e.g., the referenced specific actions, e.g., action of a vehicular robot transporting bandwidth enhancing telecommunication infrastructure to the detected location of the stadium responsively to the detection of crowd formation at the stadium, and/or additional actions set forth herein, including in reference to Table F.

At action decision block 1109, manager system 110 can render an action decision in dependence on a result of the recognition processing at block 1109 and selection actions of the user passed with request data sent at block 1402. In one embodiment of action decision block 1109, manager system 110 can query a decision data structure. In one embodiment, such a decision data structure can include a decision table as set forth in reference to Table I.

TABLE I

| Row | Service | Condition | Action decision |
|---|---|---|---|
| 1 | A001 | Dryness | Irrigation process 1 |
| | | satisfying | |
| | | threshold 1 | |
| 2 | A001 | Dryness | Irrigation process 2 |
| | | satisfying | |
| | | threshold 2 | |
| 3 | A001 | Infestation | Pesticide application process |
| 4 | A002 | Forest fire | Notification process 1 |
| 5 | A002 | Flooding | Notification process 2; aqueduct |
| | | | control process A |
| 6 | A002 | Earthquake | Notification process 3 |
| 7 | B001 | Stadium crowd | Vehicular robot transporting |
| | | formation | bandwidth increasing |
| | | | telecommunications infrastructure to |
| | | | location of stadium; control process A |
| | | | to synchronize traffic lights for |
| | | | optimized vehicle traffic flow; |
| | | | mechanical traffic barriers moved into |
| | | | blocking positions; “edge” processing |
| | | | at cellular station proximate stadium |
| | | | ported to centralized data network for |
| | | | increased bandwidth local to stadium |
| 8 | C001 | Snowfall | Vehicular robot dispatched for snow |
| | | | removal at detected locations of snow |
| | | | on road |
| . . . | . . . | . . . | . . . |

Referring to Table I, manager system 110 can output various action decisions in dependence on a condition recognized at examining block 1108. On completion of action decision block 1109, manager system 110 can send message data to one or more enterprise systems 140A-140Z. The processing to perform message sending at block 1110 can include appropriate packetizing of message data. Message data sent at block 1110 by manager system 110 can include, e.g., an enhanced image produced at block 1108 and/or can include a recognition result that has resulted from performance of examining at block 1108. Message data sent at block 1402 can alternatively or additionally include, e.g., control message data that controls a mechanical system of enterprise system 140A-140Z.

On receipt of the message data sent at block 1110, an enterprise system of enterprise systems 140A-140Z can perform one or more action at block 1403 in response to the message data. The one or more action can include, e.g., updating an internal data repository and/or using the message data is an input to a control process, e.g., a process set forth in reference to the decision data structure of Table F.

On completion of send block 1110, manager system 110 can proceed to return block 1111. At return block 1111, manager system 110 can return to a stage preceding block 1101 for receipt of a next iteration of images from respective ones of satellite imaging systems 130A-130Z. Manager system 110 can be iteratively performing the loop of blocks 1101-1111 for a deployment period of manager system 110. Satellite imaging systems 130A-130Z can be iteratively performing the loop of blocks 1301 to 1302 for a deployment period of satellite imaging systems 130A-130Z. Enterprise systems 140A-140Z can be iteratively performing the loop of blocks 1401-1404 for the deployment period of enterprise systems 140A-140Z.

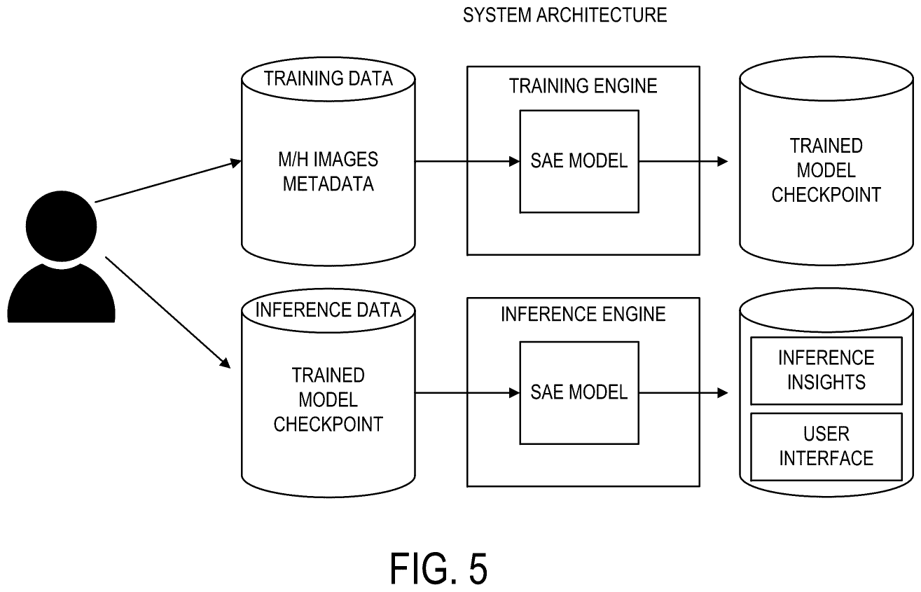

FIG. 5 illustrates an exemplary system architecture for system 100. According to a system architecture embodiment, the training engine can be used to train a task-agnostic spectral autoencoder (SAE) model that can define a spectral foundation model 7102. According to the system architecture, the SAE model can encode an incoming spectral image with sensor specific data such as, but not limited to, wavelength, bandwidth, spectral frequency, etc. Once trained, the SAE model can be fine tuned to define an inference engine provided by a specific task model 7104A-7104Z for use in providing multiple task specific predictions, such as identifying building infrastructure, vegetation, crop types, etc., The inference engine can be queried with inferences for return of predictions.

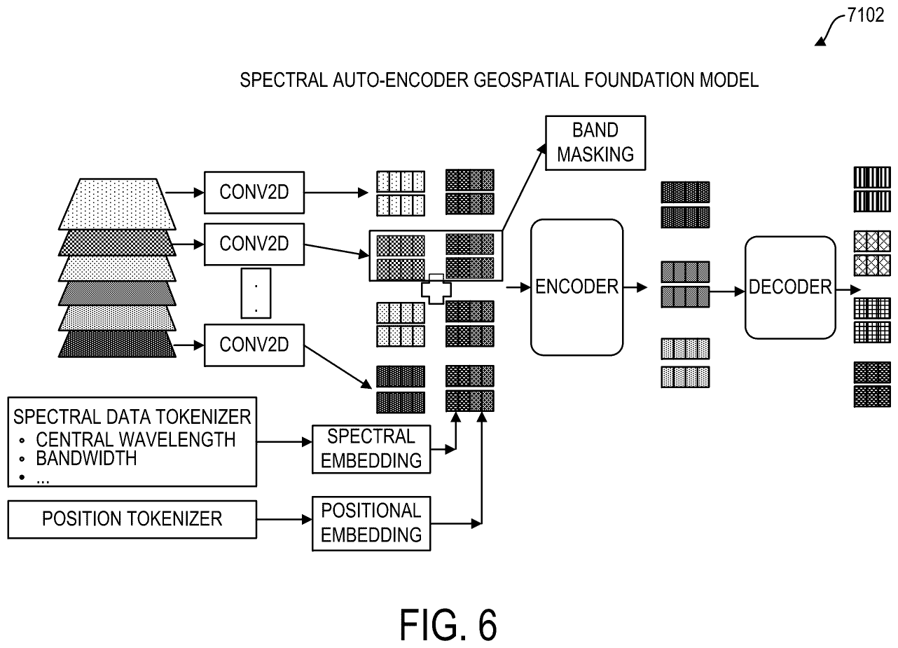

In one aspect, spectral foundation model 7102 can include features as set forth in FIG. 6. As shown in FIG. 6, spectral foundation model 7102 can include a spectral data tokenizer, a position tokenizer, a spectral embedding function, a positional embedding function, and convolution blocks.

With further reference to the features illustrated in FIG. 6, a transformer architecture can be employed. Transformer models can model the input data as sequences. Transformer models can be trained through an unsupervised training procedure by iteratively minimizing the difference between masked and predicted masked tokens.

Embodiments herein can employ a foundation model technology stack and infrastructure for enabling foundation model training, fine tuning, inference engines and pipelines to help clients and customers. The system and methods herein provide the capabilities to pre-train and task specific fine-tuning of geospatial foundation models. Embodiments herein can include a transformer based spectral autoencoder (SAE) geospatial foundation model.

The model training pipeline can include an encoding module to tokenize the input data, neural networks consisting of encoder and decoder networks with self-attention mechanism, and a training scheme that includes a masking algorithm and optimization module. The task-specific fine tuning pipeline is similar to the training pipeline with an additional module to process the input labelled data and the training strategy without masking. The inference pipeline can invoke the task specific fine tuned model with input query data and can generate predictions.

Embodiments herein set forth a system and associated methods employing spectral autoencoding (SAE) for a geospatial foundation model (GFM) based on a transformer architecture wherein spectral information of M/HS spectral imagery can be explicitly modeled and an approach to train and fine tune such a geospatial foundation model is provided. Embodiments herein can provide a method to tokenize the spectral information and create embeddings of M/HS spectral imagery using deep learning techniques. Embodiments herein can provide a method to fine tune SAE for downstream tasks such as classification, regression and segmentation problems. Embodiments herein can extend SAE for temporal M/HS spectral imagery. Embodiments herein can provide a foundation model using fixed and random masking of the stacked channels (bands) for other geospatial data such as weather and climate. Embodiments herein can provide a spectral interpolation method to leverage existing GFM checkpoint to build another GFM for different M/HS spectral imagery collected from different sensors. Embodiments herein can provide a spatial interpolation method to leverage an existing GFM checkpoint to build another GFM for different M/HS spectral imagery collected from different sensors. Embodiments herein can provide an adaptive method to train the SAE based on parameters, such as loss convergence rate, learning rate, number of channels, etc. Embodiments herein can provide a method to use a vision foundation model and build a new geospatial foundation model.

Embodiments herein recognize that multi/hyper spectral (M/HS) imagery can be employed in observations, environment, agriculture, and various other domains. Embodiments herein can provide transformer models for exploiting the position of pixels/patches along with pixel values (direct or derived features) as a sequence in an image to train a network. Embodiments herein recognize that spatio-temporal earth observation imagery does not always have structures/patterns like in camera images and that the hypothesis that M/HS imagery can be represented by a sequence of patches is invalid in most cases. To facilitate use of transformer architectures, M/HS imagery can be processed for sequence data representation. According to embodiments herein, spectral range of a sensor and the spectral channels can be treated as a discrete increasing or decreasing sequence of data which is suitable for transformer architectures. Embodiments herein recognize that GFM trained by masking spectral bands can enable a neural network to learn the spectral characteristics along with other imagery attributes using mask autoencoding (MAE). Embodiments herein can provide reflectance intensity embeddings/encodings, including a convolution neural network (CNN) for positional embeddings, spectral featurization embedding, spectral band masking, linear spectral embedding. Embodiments herein can provide a higher dimensional representation of spectral information (wavelength, bandwidth) of imagery bands.

Various available tools, libraries, and/or services can be utilized for implementation of spectral foundation model 7102 and specific task models 7104A-7104Z. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide e.g., retrieval of metadata for a given predictive model, deployment of models and management of deployed models, online deployment, scoring, batch deployment, stream deployment, monitoring and retraining deployed models. Spectral foundation model 7102 and specific task models 7104A-7104Z can include use of e.g., neural networks, transform architectures, support vector machines (SVM), Bayesian networks, and/or other machine learning technologies.

Where neural network based, a deep learning architecture can be employed for providing of spectral foundation model 7102 and/or specific task models 7104A-7104Z. Architectures employed can include, e.g., autoencoder architectures featuring an encoder and decoder, transformer architectures, seq2seq architectures, recurrent neural network (RNN) architectures, and/or long short-term memory (LSTM) architectures. Embodiments herein recognize that transformer architectures can be particularly suitable for capture of long range interactions and/or dependencies.

Certain embodiments herein may offer various technical computing advantages involving computing advantages to address problems arising in the realm of computer networks. Embodiments herein can define improvements in computer technology including in the aspect of computer image processing in which received images can be processed to predict missing information for production of an enhanced transformed image. Embodiments herein can include encoding a received spectral image so that one or more channel of a spectral image can be masked leaving remaining channels of a spectral image unmasked. Encoded information of the spectral image can be used for training of a predictive model. In one embodiment, a predictive model can be trained with iterations of training data in which training data outcome data is defined by a masked one or more channel defining a training image, and in which training data input data is input is defined by one or more remaining channel defining a training image. Trained as described, a trained predictive model can learn a relationship between masked and remaining portions of training images so that the predictive model once trained can return predictions as to missing image information when a query image is used to query the predictive model. Embodiments herein provide improvements not only in the art of computer systems, including in the aspects of image processing and recognition processing but also in the sensor arts. For example, where the sensor is not properly functioning and producing channel information of the sensor and receipt in the production of a transmitted image. Embodiments herein by use of machine learning can predict and provide missing image information thus facilitating continued satisfactory operation of the sensor system notwithstanding a noisy or malfunctioning sensor. Embodiments herein can feature a foundation model architecture in which a foundation model can be trained with use of unlabeled training and data and in which specific task models can be trained with use of labeled training data. An instance of foundation model can be subject to fine tuning training that includes training with use of labeled training data to define a specific task model, and the specific task model can be subject to further fine tuning training that includes training with use of labeled training data. In that the foundation model can be trained without use of labeled training data, the foundation model can be trained at high speed and thus, significant volumes of training data can be applied in a short time, leading to accuracy improvements of the foundation model over a limited training time. Embodiments herein can include a pipeline that continuously trains a foundation model with unlabeled training data on an ongoing basis received from data sources such as satellite imaging systems. The lack of labels associated to training data for training the foundation model can facilitate training of the foundation model at high speed with vast amounts of input training data and real time directly from a data source without interruption, e.g., interruption for purposes of applying labels to the input training data. Embodiments herein can provide improved image production, wherein with use of transformed enhanced images image recognition processing can be facilitated even the case where an incoming image includes significant noise or is otherwise deficient. Accordingly, embodiments herein can improve recognition processing including recognition processing in which a recognition result drives a process operation involving a mechanical system. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

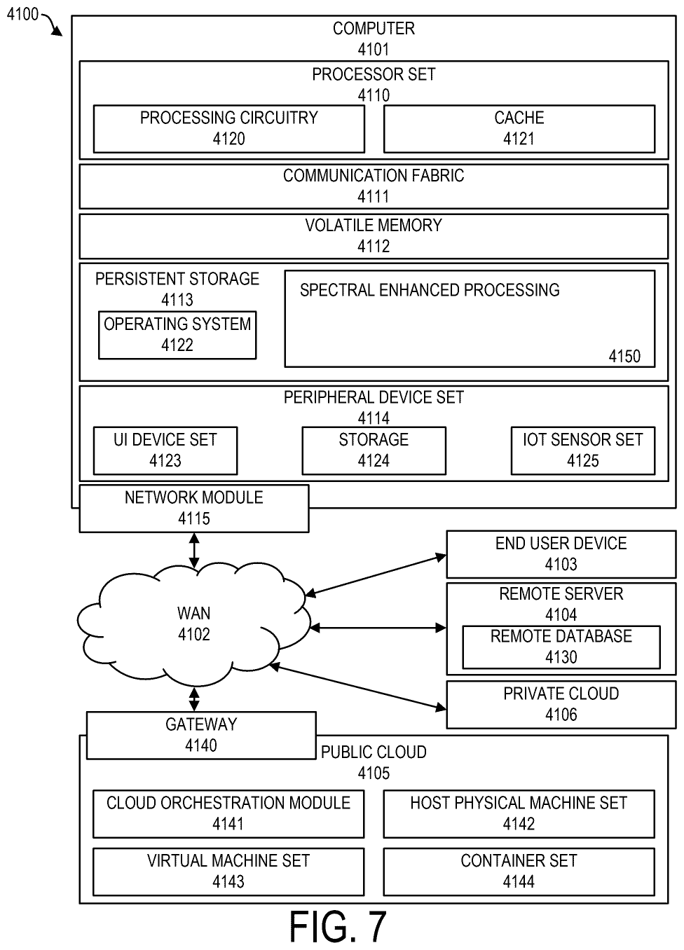

In reference to FIG. 7 there is set forth a description of a computing environment 4100 that can include one or more computer 4101. In one example, a computing node as referenced herein can be provided in accordance with computer 4101 as set forth in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 7. In one aspect, a computing environment 4100 contains an example of an environment for the execution of at least some of the computer code involved in performing the inventive methods, such as code 4150 for performing spectral enhanced processing set forth herein. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1A. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure. Further, any referenced range herein encompasses all subranges.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
encoding one or more instance of a received image with spectral mask data, wherein the spectral mask data specifies spectral information of the received image to be masked;
training one or more predictive model in dependence on the encoding;
querying the one or more predictive model with a query image; and
performing processing in dependence on an output from the querying.

2. The computer implemented method of claim 1, wherein the output from the querying includes output prediction data specifying missing spectral information, and wherein the performing processing includes examining the prediction data, and transforming the query image into a formatted spectrally enhanced image based on the examining.

3. The computer implemented method of claim 1, wherein the output from the querying includes an output one or more prediction label, and wherein the performing processing includes examining the one or more prediction label, and recognizing a condition based on the examining.

4. The computer implemented method of claim 1, wherein the output from the querying includes a plurality of pixel specific prediction labels, and wherein the performing processing includes examining pixel specific prediction labels of the plurality of pixel specific prediction labels, and recognizing a condition based on the examining.

5. The computer implemented method of claim 1, wherein the query image is provided by a multi-pixel query image, wherein the output from the querying includes a multi-pixel image associated prediction label attached to the multi-pixel query image, and wherein the performing processing includes examining the multi-pixel image associated prediction label, and recognizing a condition based on the examining.

6. The computer implemented method of claim 1, wherein the one or more predictive model includes a foundation model and a specific task model.

7. The computer implemented method of claim 1, wherein the one or more predictive model includes a foundation model and a specific task model, wherein the output from the querying includes an output one or more prediction label, and wherein the performing processing includes examining the one or more prediction label, recognizing a condition based on the examining, and returning an action decision based on the recognizing, wherein the specific task model is selected from the group consisting of a classification specific task model, a segmentation specific task model, and a regression specific task model.

8. The computer implemented method of claim 1, wherein the output from the querying includes a recognition result, and wherein the performing processing includes controlling a mechanical system in dependence on the recognition result.

9. The computer implemented method of claim 1, wherein the output from the querying includes output prediction data specifying missing spectral information, and wherein the performing processing includes examining the prediction data, and providing a formatted spectrally enhanced image based on the examining, and wherein the performing processing includes archiving the formatted spectrally enhanced image, wherein the formatted spectrally enhanced image is formatted in an M/HS format.

10. The computer implemented method of claim 1, wherein the output from the querying includes a plurality of pixel specific prediction labels, and wherein the performing processing includes examining pixel specific prediction labels of the plurality of pixel specific prediction labels, and recognizing a condition based on the examining, an storing a recognition result resulting from the recognizing.

11. The computer implemented method of claim 1, wherein the performing processing includes controlling a mechanical system in dependence on a recognition result, the recognition result based on an examining of the output.

12. The computer implemented method of claim 1, wherein the training the one or more predictive model in dependence on the encoding includes training a foundation model using training data in which spectral channels are masked, training an instance of the foundation model with use of fine tuning training to define a specific task model, and further training the specific task model with use of fine tuning training, wherein the performing processing includes returning an action decision based on an examining of the output.

13. The computer implemented method of claim 1, wherein the training the one or more predictive model in dependence on the encoding includes training a foundation model using unlabeled training data in which spectral channels are masked, training an instance of the foundation model employing fine tuning training with use of labeled training data to define a specific task model, and further training the specific task model employing fine tuning training with use of additional labeled training data, wherein the output from the querying includes an output one or more prediction label, and wherein the performing processing includes examining the one or more prediction label, recognizing a condition based on the examining, and returning an action decision based on the recognizing.

14. The computer implemented method of claim 1, wherein the method is characterized by one or more of the following selected from the group consisting of: (a) the received image is a satellite spectral image, (b) the received image is defined by an X×Y pixel array in which pixel intensity values for respective pixels of the array are provided for M channels, (c) the received image includes M channels, and (d) the received image includes M channels, and wherein the spectral mask data specifies selective masking of a subset of the M channels.

15. The computer implemented method of claim 1, wherein the encoding one or more instance of a received image with spectral mask data includes encoding a first instance of the received image with first spectral mask data that specifies selective masking of a first channel of the received image, and wherein the encoding one or more instance of the received image with spectral mask data includes encoding a second instance of the received image with second spectral mask data that specifies selective masking of a second channel of the received image.

16. The computer implemented method of claim 1, wherein the encoding one or more instance of a received image with spectral mask data includes encoding a first instance of the received image with first spectral mask data that specifies selective masking of a first channel of the received image, and wherein the encoding one or more instance of a received image with spectral mask data includes encoding a second instance of the received image with second spectral mask data that specifies selective masking of a second channel of the received image, wherein the training the one or more predictive model in dependence on the encoding includes applying a first training dataset to a foundation model with the first channel masked, and applying a second training dataset for the foundation model with the second channel masked.

17. The computer implemented method of claim 1, wherein the encoding one or more instance of a received image with spectral mask data includes encoding a first instance of the received image with first spectral mask data that specifies selective masking of a first channel of the received image, and wherein the encoding one or more instance of a received image with spectral mask data includes encoding a second instance of the received image with second spectral mask data that specifies selective masking of a second channel of the received image, wherein the training the one or more predictive model in dependence on the encoding includes applying a first training dataset to a foundation model with the first channel masked, and applying a second training dataset for the foundation model with the second channel masked, wherein the training the one or more predictive model in dependence on the encoding includes training the foundation model using unlabeled training data in which spectral channels are masked in accordance with the encoding, training an instance of the foundation model employing fine tuning training with use of labeled training data to define a specific task model, and further training the specific task model employing fine tuning training with use of additional labeled training data, wherein the performing processing includes returning an action decision based on an examining of the output, wherein the output from the querying includes an output one or more prediction label output from the specific task model, and wherein the performing processing includes examining the one or more prediction label, recognizing a condition based on the examining, and retuning an action decision based on the recognizing.

18. The computer implemented method of claim 1, wherein the performing processing in dependence on an output from the querying includes returning an action decision in dependence on an output from the querying.

19. A system comprising:
a memory;
at least one processor in communication with the memory; and
program instructions executable by one or more processor via the memory to perform a method comprising:
encoding one or more instance of a received image with spectral mask data, wherein the spectral mask data specifies spectral information of the received image to be masked;
training a predictive model in dependence on the encoding;
querying the predictive model with a query image for production of an enhanced image; and
performing processing in dependence on the enhanced image.

20. A computer program product comprising:
a computer readable storage medium readable by one or more processing circuit and storing instructions for execution by one or more processor for performing a method comprising:
encoding one or more instance of a received image with spectral mask data, wherein the spectral mask data specifies spectral information of the received image to be masked;
training a predictive model in dependence on the encoding;
querying the predictive model with a query image for production of an enhanced image; and
performing processing in dependence on the enhanced image.
